(19) United States
(12) Patent Application Publication
(10) Pub. No.: US 2015/0144271 A1
(43) Pub. Date: May 28, 2015

(54) METHOD OF SEPARATING PLATES

(71) Applicant: NITTO DENKO CORPORATION, Ibaraki-shi (JP)

(72) Inventor: Masato Fujita, Ibaraki-shi (JP)

(21) Appl. No.: 14/540,336

(22) Filed: Nov. 13, 2014

(30) Foreign Application Priority Data
Nov. 28, 2013 (JP) 2013-246123

(51) Int. Cl. B32B 43/00; B32B 38/10

(52) U.S. Cl. CPC B32B 43/006; B32B 38/10
USPC 156/701; 156/762

(57) ABSTRACT

It is an object of the present invention to provide a method that can separate two plates laminated via a pressure-sensitive adhesive sheet, smoothly, efficiently, and accurately without such force (load) that large strain (deformation) leading to breakage or cracking occurs being substantially applied to the plates. The method of separating plates according to the present invention is a method of separating two plates laminated via a double-sided pressure-sensitive adhesive sheet, comprising placing a cutting tool having a cutting edge angle of not more than 25° and a thickness of not more than 20 mm, on a side of a structure composed of a double-sided pressure-sensitive adhesive sheet and two plates, between the double-sided pressure-sensitive adhesive sheet and the plate, and applying force in a normal direction of the plate.

### TECHNICAL FIELD

The present invention relates to a method of separating plates and an apparatus for separating plates. Particularly, the present invention relates to a method of separating two plates laminated via a double-sided pressure-sensitive adhesive sheet, and an apparatus for separating plates that can carry out the method of separating plates, accurately and efficiently.

### BACKGROUND ART

In recent years, displays such as liquid crystal displays (LCDs), and input apparatuses used in combination with the displays such as touch panels have been widely used in various fields. In the manufacture and the like of these displays and input apparatuses, transparent pressure-sensitive adhesive sheets are used in applications for the lamination of optical members. For example, a transparent pressure-sensitive adhesive sheet is used for the lamination of a touch panel, a lens, or the like and a display (an LCD or the like) (for example, see Patent Literatures 1 to 3).

For the pressure-sensitive adhesive sheets used in the applications, in recent years, the demand for reseparation (rework) when relamination or the like is necessary after optical members are laminated has increased. However, when two optical members (particularly, high rigidity optical members, thin film optical members, or the like) laminated via the conventional pressure-sensitive adhesive sheet are reseparated, force is applied to the optical members, and problems such as the breakage of the optical members and the cracking of the optical members occur, and rework may be difficult.

For such problems, methods of separating plates were proposed (for example, see Patent Literature 4).

### CITATION LIST

### Patent Literature

Patent Literature 1: Japanese Patent Laid-Open No. 2003-238915
Patent Literature 2: Japanese Patent Laid-Open No. 2003-342542
Patent Literature 3: Japanese Patent Laid-Open No. 2004-231723
Patent Literature 4: Japanese Patent Laid-Open No. 2013-173913

### SUMMARY OF INVENTION

### Technical Problem

For the pressure-sensitive adhesive sheets used in the applications, the demand for reseparation particularly at low temperature has increased.

In addition, the following properties (i) and (ii) have been required at higher levels. In other words, reseparability has been required at a higher level.

(i) A property of being capable of inhibiting the occurrence of the breakage or cracking of optical members due to the application of force to the optical members when two optical members laminated via a double-sided pressure-sensitive adhesive sheet are separated

(ii) A property of being capable of separating optical members smoothly, efficiently, and accurately when two optical members laminated via a double-sided pressure-sensitive adhesive sheet are separated

Further, the reseparation properties (reseparability) are required not only in applications for reuse (rework) of optical members but in various applications.

Therefore, it is an object of the present invention to provide a method that can separate two plates laminated via a pressure-sensitive adhesive sheet, smoothly, efficiently, and accurately without such force (load) that large strain (deformation) leading to breakage or cracking occurs being substantially applied to the plates.

In addition, it is another object of the present invention to provide an apparatus for separating plates that can carry out the method of separating plates, accurately and efficiently.

### Solution to Problem

The present inventors have studied diligently and as a result found that in a method of separating two plates laminated via a double-sided pressure-sensitive adhesive sheet, when a cutting tool having a particular structure is placed on a side of a structure composed of a double-sided pressure-sensitive adhesive sheet and two plates between the double-sided pressure-sensitive adhesive sheet and the plate, and force is applied in the normal direction of the plate, the two plates laminated via the pressure-sensitive adhesive sheet can be separated smoothly, efficiently, and accurately without such force (load) that large strain (deformation) leading to breakage or cracking occurs being substantially applied to the plates, and the plate separated by the separation method is easily reworked, thus completing the present invention.

Specifically, the present invention provides a method of separating two plates laminated via a double-sided pressure-sensitive adhesive sheet, comprising placing a cutting tool having a cutting edge angle of not more than 25° and a thickness of not more than 20 mm, on a side of a structure composed of a double-sided pressure-sensitive adhesive sheet and two plates, between the double-sided pressure-sensitive adhesive sheet and the plate, and applying force in a normal direction of the plate.

In the method of separating plates, it is preferred that temperature in separating the plates be a temperature at which a storage modulus of a pressure-sensitive adhesive layer of the double-sided pressure-sensitive adhesive sheet measured by dynamic viscoelasticity measurement is not less than 1.0×10⁷ Pa.

In the method of separating plates, it is preferred that the double-sided pressure-sensitive adhesive sheet be a double-sided acrylic pressure-sensitive adhesive sheet having an acrylic pressure-sensitive adhesive layer.

In the method of separating plates, it is preferred that at least one of the two plates be an optical member.

Further, the present invention provides an apparatus for separating two plates laminated via a double-sided pressure-sensitive adhesive sheet, comprising a cutting tool having a cutting edge angle of not more than 25° and a thickness of not more than 20 mm, and being capable of placing the cutting tool, on a side of a structure composed of a double-sided pressure-sensitive adhesive sheet and two plates, between the double-sided pressure-sensitive adhesive sheet and the plate and applying force in a normal direction of the plate.

### Advantageous Effect of Invention

The method of separating plates according to the present invention has the above configuration and therefore can separate the two plates laminated via the pressure-sensitive adhesive sheet, smoothly, efficiently, and accurately without such force (load) that large strain (deformation) leading to breakage or cracking occurs being substantially applied to the plates.

### BRIEF DESCRIPTION OF DRAWINGS

FIG. 1 shows schematic views showing a series of flows for a method of separating plates according to the present invention.

FIG. 2 is a schematic cross-sectional view of a cutting tool used in the method of separating plates according to the present invention.

FIG. 3 shows top schematic views showing specific examples of the cutting tool.

FIG. 4 is a top schematic view showing one example of a cutting tool having a triangular blade shape.

FIG. 5 shows schematic views showing a series of flows for the method of separating plates according to the present invention.

FIG. 6 shows schematic top views each showing one example of an apparatus for separating plates according to the present invention.

### DESCRIPTION OF EMBODIMENTS

### [Method of Separating Plates]

A method of separating plates according to the present invention is a method of separating two plates laminated via a double-sided pressure-sensitive adhesive sheet.

As used herein, a “pressure-sensitive adhesive sheet” also includes the meaning of a “pressure-sensitive adhesive tape”. In other words, a pressure-sensitive adhesive sheet may be a pressure-sensitive adhesive tape having a tape-like form.

The method of separating plates according to the present invention is a method of separating two plates laminated via a double-sided pressure-sensitive adhesive sheet by placing a cutting tool having a cutting edge angle of not more than 25° and a thickness of not more than 20 mm, on a side of a structure composed of a double-sided pressure-sensitive adhesive sheet and two plates, between the double-sided pressure-sensitive adhesive sheet and the plate, and applying force in the normal direction of the plate.

As used herein, the “structure composed of a double-sided pressure-sensitive adhesive sheet and two plates” is sometimes referred to as a “structure a”, and the “cutting tool having a cutting edge angle of not more than 25° and a thickness of not more than 20 mm” is sometimes referred to as a “cutting tool a”.

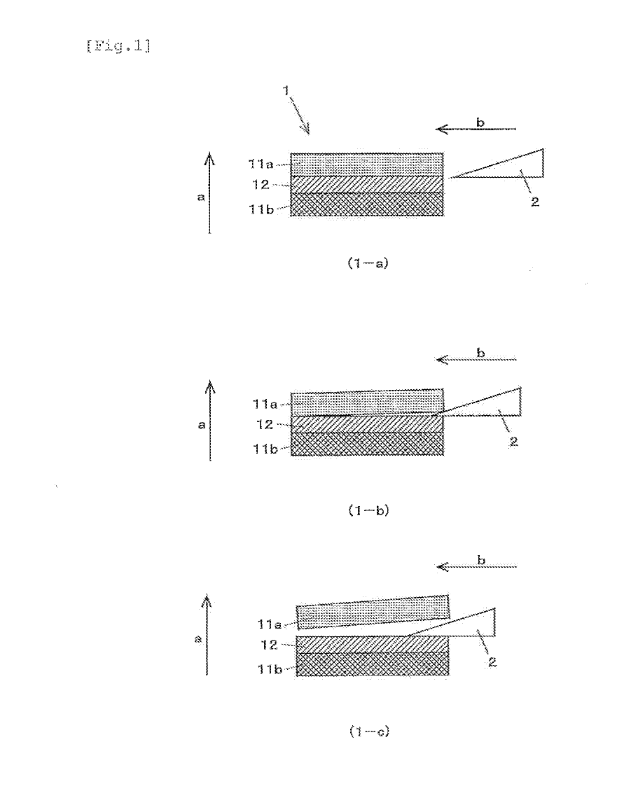

One example of the method of separating plates according to the present invention will be described below using FIG. 1. The method of separating plates according to the present invention is not limited to the method shown in FIG. 1. FIG. 1 shows schematic views showing a series of flows (steps) for the method of separating plates according to the present invention. Each figure in FIG. 1 is a side view.

In FIG. 1, (1-a) shows a state before the method of separating plates according to the present invention is carried out, (1-b) shows a state in which the method of separating plates according to the present invention is carried out, and (1-c) shows a state after the method of separating plates according to the present invention is carried out. In FIG. 1, reference characters 11a and 11b denote plates, reference numeral 12 denotes a double-sided pressure-sensitive adhesive sheet, reference numeral 1 denotes a structure a (a structure composed of a double-sided pressure-sensitive adhesive sheet and two plates), and reference numeral 2 denotes a cutting tool a (a cutting tool having a cutting tip angle of not more than 25° and a thickness of not more than 20 mm). In addition, a denotes the normal direction of the plate and the thickness direction of the structure a. Further, b denotes the horizontal direction and the surface direction (plane direction) of the structure a.

In (1-a) in FIG. 1, the cutting tool a (2) is positioned so as to touch between the double-sided pressure-sensitive adhesive sheet 12 and the plate 11a on a side of the structure 1 when the cutting tool a is placed on the structure 1. In (1-a) in FIG. 1, the cutting tool a (2) is positioned so as to touch between the double-sided pressure-sensitive adhesive sheet 12 and the plate 11a on a side of the structure 1, but in the method of separating plates according to the present invention, the cutting tool a (2) may be positioned so as to touch between the double-sided pressure-sensitive adhesive sheet 12 and the plate 11b on a side of the structure 1.

In (1-b) in FIG. 1, the cutting tool a (2) is placed in the horizontal direction between the double-sided pressure-sensitive adhesive sheet 12 and the plate 11a on the side of the structure 1, and force is applied to the cutting tool a (2). By this force in the horizontal direction applied to the cutting tool a (2), the cutting tool a (2) is inserted at the interface between the double-sided pressure-sensitive adhesive sheet 12 and the plate 11a, and the cutting tool a (2) moves in the horizontal direction (the plane direction of the plate) between the double-sided pressure-sensitive adhesive sheet 12 and the plate 11a. Then, the cutting tool a (2) is inserted at the interface between the double-sided pressure-sensitive adhesive sheet 12 and the plate 11a and moves in the horizontal direction between the double-sided pressure-sensitive adhesive sheet 12 and the plate 11a. Thereby, force acts on the plate 11a in the normal direction a, and separation occurs between the plate 11a and the double-sided pressure-sensitive adhesive sheet 12.

In (1-c) in FIG. 1, force acts on the plate 11a in the normal direction a, separation occurs between the plate 11a and the double-sided pressure-sensitive adhesive sheet 12, and the plate 11a is separated. In other words, in (1-c) in FIG. 1, the structure 1 is separated into “the plate 11a” and “a structure composed of the plate 11b and the double-sided pressure-sensitive adhesive sheet 12.”

In this manner, in the method of separating plates according to the present invention, the plate 11a and the plate 11b laminated via the double-sided pressure-sensitive adhesive sheet 12 are separated.

In the method of separating plates according to the present invention, force is applied to at least one plate of the two plates laminated via the double-sided pressure-sensitive adhesive sheet at least in the normal direction of the plate to separate the two plates. “The normal direction of the plate” refers to a linear direction perpendicular to a surface of the plate (for example, the surface of the plate on which the double-sided pressure-sensitive adhesive sheet is laminated).

In addition, “applying force in the normal direction of the plate” in the method of separating plates according to the present invention refers to applying force including a component in the normal direction of the plate. In other words, it refers to the fact that when the applied force is resolved, a component in the normal direction is present. In other words, it includes a case where force is applied only in the normal direction of the plate, and a case where force is applied in a direction oblique to a surface of the plate, and excludes a case where force is applied only in the direction parallel to a surface of the plate (for example, a case where the two plates are translated without applying force in the normal direction, or the two plates are twisted without applying force in the normal direction).

In addition, in the method of separating plates according to the present invention, the cutting tool a (the cutting tool having a cutting edge angle of not more than 25° and a thickness of not more than 20 mm) is used. The angle of the cutting edge in the cutting tool a is not more than 25° (degrees) in terms of inhibiting at a higher level, for the two plates laminated via the pressure-sensitive adhesive sheet, substantial application of such force that large strain leading to breakage or cracking occurs, to the plates, to separate the two plates smoothly, efficiently, and accurately. The angle of the cutting edge is not particularly limited as long as it is not more than 25°, and it is more preferably not more than 20°, further preferably not more than 15°.

Further, the thickness of the cutting tool a in the method of separating plates according to the present invention is not more than 20 mm in terms of inhibiting at a higher level, for the two plates laminated via the pressure-sensitive adhesive sheet, substantial application of such force that large strain leading to breakage or cracking occurs, to the plates, to separate the two plates smoothly, efficiently, and accurately. The thickness of the cutting tool a is not particularly limited as long as it is not more than 20 mm, and it is more preferably not more than 10 mm, further preferably not more than 5 mm. The thickness of the cutting tool is not particularly limited and is preferably not less than 0.1 mm, more preferably not less than and 1 mm.

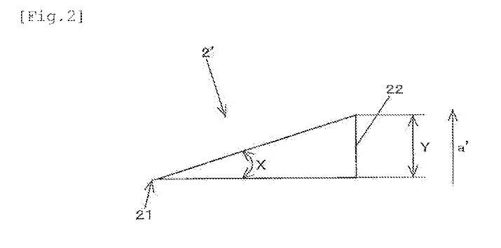

A schematic cross-sectional view of the cutting tool a used in the method of separating plates according to the present invention is shown in FIG. 2. In FIG. 2, reference numeral 2′ denotes the cutting tool a, X denotes the angle of the cutting edge in the cutting tool a, and Y denotes the thickness of the cutting tool a. In addition, reference numeral 21 denotes the cutting edge of the cutting tool a, reference numeral 22 denotes the back portion of the cutting tool a, and the direction a′ denotes the thickness direction of the cutting tool a.

The blade shape of the cutting tool a in the method of separating plates according to the present invention is not particularly limited. Examples thereof include a flat blade shape, an oblique blade shape, a triangular blade shape (mountain blade shape), a saw blade shape, a half-moon blade shape, a semicircular blade shape, and a valley blade shape. In addition, the blade shape of the cutting tool a may be a combined shape of these.

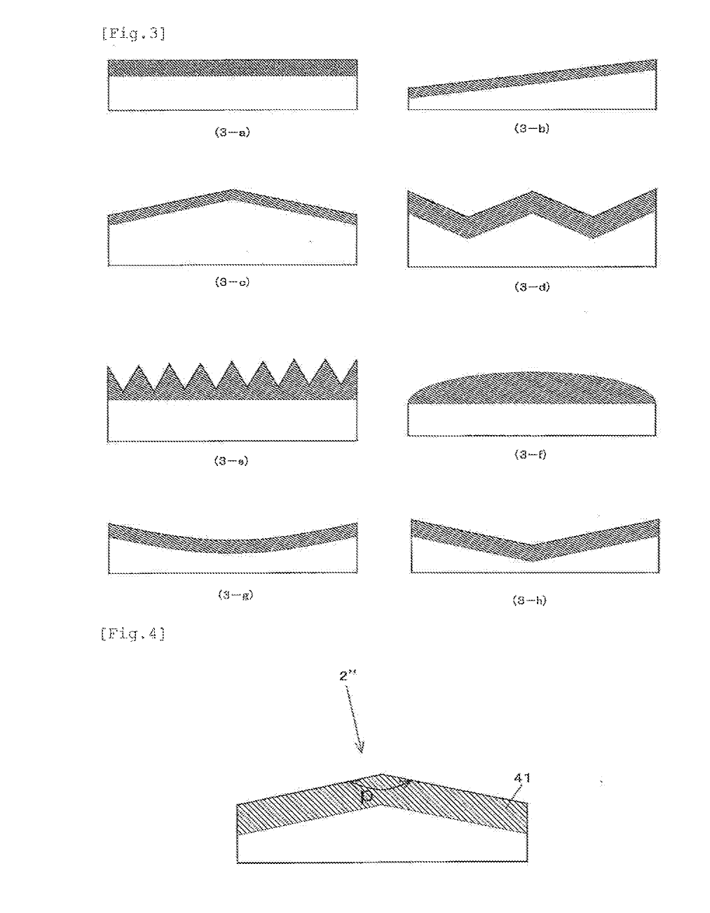

Top schematic views of specific examples regarding the cutting tool a in the method of separating plates according to the present invention are shown in FIG. 3. In FIG. 3, (3-a) shows one example of the cutting tool a having a flat blade shape, (3-b) shows one example of the cutting tool a having an oblique blade shape, (3-c) shows one example of the cutting tool a having a triangular blade shape (mountain blade shape), (3-d) and (3-e) each show one example of the cutting tool a having a saw blade shape, (3-f) shows one example of the cutting tool a having a half-moon blade shape, (3-g) shows one example of the cutting tool a having a semicircular blade shape, and (3-h) shows one example of the cutting tool a having a valley blade shape. In addition, when the cutting tool a is a cutting tool having a saw blade shape, the number of tips (points) in the saw blade is not particularly limited. In (3-a) to (3-h), the regions shown by oblique lines are blade portions.

Among them, the blade shape of the cutting tool a is preferably the triangular blade shape as shown in (3-c) in that stress is likely to concentrate on the tip (point) and the cutting tool can be easily inserted, that resistance when a separation portion formed by inserting the cutting tool expands in the plane direction of the structure can be reduced, and that the movement of the cutting tool in the horizontal direction between the double-sided pressure-sensitive adhesive sheet and the plate can be made more smooth.

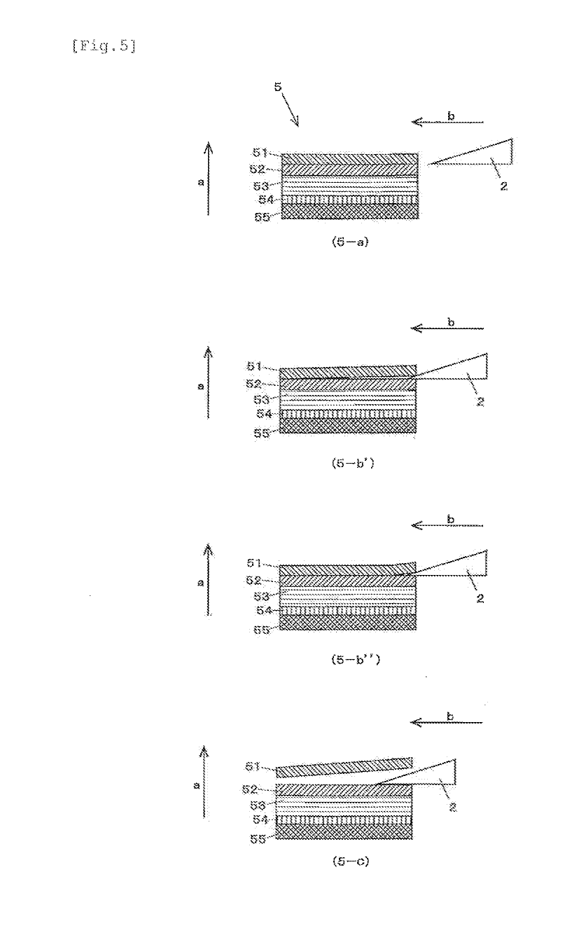

When the cutting tool a is a cutting tool having a triangular blade shape, the angle of the tip of the triangular blade is not particularly limited and is preferably not less than 90°, more preferably not less than 120°, in terms of inhibiting at a higher level, substantial application of such force that large strain leading to breakage or cracking occurs, to the plates, to separate the two plates smoothly, efficiently, and accurately. In addition, the angle is preferably not more than 180°. The angle of the tip of the triangular blade in the cutting tool having a triangular blade shape corresponds to an angle p in FIG. 4.

FIG. 4 is a top schematic view of one example of the cutting tool a having a triangular blade shape. Reference numeral 2″ denotes the cutting tool a, and reference numeral 41 denotes the blade portion in the cutting tool a. In addition, p denotes the angle of the tip of the triangular blade.

The material of the cutting tool a in the method of separating plates according to the present invention is not particularly limited, and examples thereof include resins and metals. Among them, metals are preferred in terms of strength, in terms of inhibiting nicks in repeated use, and in terms of easy adjustment of the cutting edge angle. Particularly, the cutting tool a is preferably a metal blade also because it is preferred that the two plates can be separated stably, smoothly, efficiently, and accurately even if the cutting tool a is used at low temperature, for example, a temperature at which the storage modulus of the pressure-sensitive adhesive layer of the double-sided pressure-sensitive adhesive sheet measured by dynamic viscoelasticity measurement is not less than 1.0×10⁷ Pa. For example, the cutting tool a is preferably a stainless steel blade.

In the method of separating plates according to the present invention, the cutting tool a is placed on a side of the structure a (the structure composed of the double-sided pressure-sensitive adhesive sheet and the two plates) between the double-sided pressure-sensitive adhesive sheet and the plate, and the portion in the structure a where the cutting tool a is placed is not particularly limited. In other words, the cutting tool a may be placed on the entire side of the structure a, or the cutting tool a may be placed on a portion of the side of the structure a. For example, the cutting tool may be placed on only one side of the structure a, or the cutting tools may be placed on two opposed sides (opposite faces) of the structure a. Further, the cutting tool a may be placed on a corner of the structure a.

In the method of separating plates according to the present invention, the temperature in separating the plates (sometimes referred to as “separation temperature”) is not particularly limited and is preferably a temperature at which the storage modulus of the pressure-sensitive adhesive layer of the double-sided pressure-sensitive adhesive sheet measured by dynamic viscoelasticity measurement is not less than 1.0×10⁷ Pa, more preferably a temperature at which the storage modulus is not less than 1.0×10⁸ Pa.

At such a temperature, since the cohesion of the pressure-sensitive adhesive layer of the double-sided pressure-sensitive adhesive sheet is high, the force of the double-sided pressure-sensitive adhesive sheet to adhere to the plates (the adhesive strength of the double-sided pressure-sensitive adhesive sheet) weakens, and thus the double-sided pressure-sensitive adhesive sheet is less likely to deform or tear. Therefore, the two plates are likely to be easily separated in a short time without applying such force (load) that large strain (deformation) leading to breakage or cracking occurs. Therefore, the plate and the double-sided pressure-sensitive adhesive sheet can be separated more efficiently, smoothly, and accurately at the interface between the plate and the double-sided pressure-sensitive adhesive sheet. This is particularly advantageous when a high rigidity plate such as a glass plate or a thin film-like plate (a plate having small thickness) is used.

In addition, at such a temperature, the remaining of the pressure-sensitive adhesive of the double-sided pressure-sensitive adhesive sheet on the plate after separation (adhesive residue) can be further inhibited. This is advantageous when the plate after separation is reused (reworked).

Further, at such a temperature, since the cohesion of the pressure-sensitive adhesive layer of the double-sided pressure-sensitive adhesive sheet is high, the adhesive strength of the double-sided pressure-sensitive adhesive sheet weakens, and therefore, only by separating part of the adhesive face between the double-sided pressure-sensitive adhesive sheet and the plate, the double-sided pressure-sensitive adhesive sheet and the plate can be separated, which is triggered by the separated place. This leads to the fact that the two plates can be separated easily and with small force in a short time.

The storage modulus is measured by dynamic viscoelasticity measurement. The storage modulus is measured, for example, by the following method.

### (Method of Measuring Storage Modulus)

It is possible to laminate a plurality of the pressure-sensitive adhesive layers of the double-sided pressure-sensitive adhesive sheet to a thickness of the order of about 2 mm and perform measurement by “Advanced Rheometric Expansion System (ARES)” manufactured by Rheometric Scientific under the condition of a frequency of 1 Hz in the range of −60 to 100° C. at a temperature increase rate of 5° C./min.

Examples of the temperature at which the storage modulus of the pressure-sensitive adhesive layer of the double-sided pressure-sensitive adhesive sheet measured by dynamic viscoelasticity measurement is not less than 1.0×10⁷ Pa include temperatures of not less than −200° C. and not more than 0° C. The lower limit of the temperature is more preferably −100° C., further preferably −60° C. Particularly, in the method of separating plates according to the present invention, a double-sided pressure-sensitive adhesive sheet having a pressure-sensitive adhesive layer in which the storage modulus measured by dynamic viscoelasticity measurement is not less than 1.0×10⁷ Pa at −60° C. to 0° C. is preferably used.

In the method of separating plates according to the present invention, the means of adjusting the separation temperature to the temperature at which the storage modulus of the pressure-sensitive adhesive layer of the double-sided pressure-sensitive adhesive sheet measured by dynamic viscoelasticity measurement is not less than 1.0×10⁷ Pa is not particularly limited, and general cooling means (for example, cooling using liquid nitrogen, cooling using dry ice, and cooling using a low temperature cooling apparatus) can be used.

### (Double-Sided Pressure-Sensitive Adhesive Sheet)

The method of separating plates according to the present invention is a method of separating two plates laminated via a double-sided pressure-sensitive adhesive sheet. The double-sided pressure-sensitive adhesive sheet has at least one pressure-sensitive adhesive layer.

The double-sided pressure-sensitive adhesive sheet may also have a base material, other layers (for example, an intermediate layer and a primer layer), and the like in addition to the pressure-sensitive adhesive layer. Only one of each of the pressure-sensitive adhesive layer, the base material, and the other layers may be provided, or two or more of each may be provided.

The double-sided pressure-sensitive adhesive sheet may be a double-sided pressure-sensitive adhesive sheet having no base material (base material layer), the so-called “base material-less type” double-sided pressure-sensitive adhesive sheet (sometimes referred to as a “base material-less double-sided pressure-sensitive adhesive sheet”), or a double-sided pressure-sensitive adhesive sheet having a base material (sometimes referred to as a “double-sided pressure-sensitive adhesive sheet with a base material”). Examples of the base material-less double-sided pressure-sensitive adhesive sheet include a double-sided pressure-sensitive adhesive sheet composed of only a pressure-sensitive adhesive layer. Examples of the double-sided pressure-sensitive adhesive sheet having a base material include a double-sided pressure-sensitive adhesive sheet having pressure-sensitive adhesive layers on both surfaces of a base material.

The “base material (base material layer)” is a portion laminated on an object (adherend) together with the pressure-sensitive adhesive layer when the double-sided pressure-sensitive adhesive sheet is used (laminated) on the object, and does not include a release liner (a separator or a release film) peeled during the use (lamination) of the double-sided pressure-sensitive adhesive sheet.

The base material in the double-sided pressure-sensitive adhesive sheet is not particularly limited, and examples thereof include paper base materials such as paper; fiber base materials such as cloths, nonwoven fabrics, and nets; metal, base materials such as metal foil and metal plates; plastic base materials such as films and sheets of various resins; rubber base materials such as rubber sheets; and foams such as foamed sheets, and laminates thereof (particularly, laminates of plastic base materials and other base materials, laminates of plastic films (or sheets), and the like).

Examples of raw materials of the plastic base materials include polyester resins such as polyethylene terephthalate (PET), acrylic resins such as polymethyl methacrylate (PMMA), polycarbonates, triacetyl cellulose (TAC), polysulfones, polyarylates, polyimides, polyvinyl chloride, polyvinyl acetate, polyethylene, polypropylene, ethylene-propylene copolymers, and cyclic olefin polymers such as the trade name “ARTON (cyclic olefin polymer; manufactured by JSR)” and the trade name “ZEONOR (cyclic olefin polymer; manufactured by ZEON Corporation)”. The raw materials can be used alone, or two or more of the raw materials can be used in combination.

Further, the base material in the double-sided pressure-sensitive adhesive sheet may be any of various optical films such as antireflection (AR) films, polarizing plates, and phase difference plates.

The thickness of the base material is not particularly limited and is preferably 1 to 500 μm.

In addition, known common surface treatment such as physical treatment such as corona discharge treatment or plasma treatment, or chemical treatment such as primer treatment may be appropriately performed on the surfaces of the base material.

The pressure-sensitive adhesive layer in the double-sided pressure-sensitive adhesive sheet is a pressure-sensitive adhesive layer comprising a base polymer and is not particularly limited. The pressure-sensitive adhesive constituting the pressure-sensitive adhesive layer is not particularly limited, and examples thereof include acrylic pressure-sensitive adhesives, urethane pressure-sensitive adhesives, rubber pressure-sensitive adhesives, silicone pressure-sensitive adhesives, polyester pressure-sensitive adhesives, polyamide pressure-sensitive adhesives, epoxy pressure-sensitive adhesives, vinyl alkyl ether pressure-sensitive adhesives, fluorine pressure-sensitive adhesives, and polyolefin pressure-sensitive adhesives. In other words, the double-sided pressure-sensitive adhesive sheet in the method of separating plates according to the present invention is not particularly limited and may be, for example, a double-sided acrylic pressure-sensitive adhesive sheet, a double-sided urethane pressure-sensitive adhesive sheet, a double-sided rubber pressure-sensitive adhesive sheet, a double-sided silicone pressure-sensitive adhesive sheet, a double-sided polyester pressure-sensitive adhesive sheet, a double-sided polyamide pressure-sensitive adhesive sheet, a double-sided epoxy pressure-sensitive adhesive sheet, a double-sided vinyl alkyl ether pressure-sensitive adhesive sheet, a double-sided fluorine pressure-sensitive adhesive sheet, or a double-sided polyolefin pressure-sensitive adhesive sheet. The pressure-sensitive adhesives can be used alone, or two or more of the pressure-sensitive adhesives can be used in combination.

The pressure-sensitive adhesive layer is formed of a pressure-sensitive adhesive composition. The pressure-sensitive adhesive composition means a composition used for the formation of the pressure-sensitive adhesive layer and includes the meaning of a composition used for the formation of the pressure-sensitive adhesive.

The pressure-sensitive adhesive composition may have any form. The pressure-sensitive adhesive composition may be, for example, an emulsion type pressure-sensitive adhesive composition, a solvent type (solution type) pressure-sensitive adhesive composition, an active energy ray curing type pressure-sensitive adhesive composition, or a heat melting type (hot melt type) pressure-sensitive adhesive composition. Particularly, the pressure-sensitive adhesive composition is preferably a solvent type pressure-sensitive adhesive composition or an active energy ray curing type pressure-sensitive adhesive composition. Examples of the solvent type pressure-sensitive adhesive composition include a pressure-sensitive adhesive composition comprising a base polymer as an essential component. In addition, examples of the active energy ray curing type pressure-sensitive adhesive composition include a pressure-sensitive adhesive composition comprising as an essential component a mixture of monomer components constituting a base polymer or a partial polymer thereof.

As used herein, the “mixture of monomer components constituting a base polymer” is sometimes referred to as a “monomer mixture,” and the monomer mixture includes the case of being composed of only one monomer. In addition, the partial polymer means a material in which one or two or more of monomer components constituting a base polymer are partially polymerized.

The pressure-sensitive adhesive layer contains a base polymer. The content of the base polymer in the pressure-sensitive adhesive layer is not particularly limited and is preferably not less than 70% by weight, more preferably not less than 80% by weight, based on the total amount (total weight, 100% by weight) of the pressure-sensitive adhesive layer. For example, when the pressure-sensitive adhesive layer is an acrylic pressure-sensitive adhesive layer comprising an acrylic polymer as a base polymer, the content of the acrylic polymer in the acrylic pressure-sensitive adhesive layer is preferably not less than 70% by weight, more preferably not less than 80% by weight, based on the total amount (total weight, 100% by weight) of the acrylic pressure-sensitive adhesive layer.

The pressure-sensitive adhesive layer is preferably an acrylic pressure-sensitive adhesive layer in terms of the ease of polymer design and the ease of adjustment of the function of the pressure-sensitive adhesive layer. In other words, in the method of separating plates according to the present invention, the double-sided pressure-sensitive adhesive sheet used for the lamination of the two plates is preferably a double-sided acrylic pressure-sensitive adhesive sheet having an acrylic pressure-sensitive adhesive layer containing an acrylic polymer as a base polymer.

The acrylic polymer that is the base polymer in the acrylic pressure-sensitive adhesive layer preferably comprises as a constituent monomer component an alkyl (meth)acrylate ester having an alkyl group as a main monomer component.

As used herein, “(meth)acryl” means “acryl” and/or “methacryl” (one or both of “acryl” and “methacryl”). In addition, an “alkyl group” means a linear or branched alkyl group unless otherwise noted.

In addition, the alkyl (meth)acrylate ester having an alkyl group can be used alone, or two or more alkyl (meth)acrylate ester having an alkyl groups can be used in combination.

In the acrylic polymer, the proportion of the alkyl (meth)acrylate ester having an alkyl group is not particularly limited and is preferably not less than 45% by weight, more preferably not less than 50% by weight, and further preferably not less than 60% by weight, based on the total amount (total weight, 100% by weight) of the constituent monomer components.

The acrylic polymer preferably comprises an alkyl (meth)acrylate ester having an alkyl group having 4 to 24 carbon atoms as a constituent monomer component in terms of the ease of obtaining an acrylic pressure-sensitive adhesive layer having the property of decreasing adhesive strength at low temperature (for example, preferably −200° C. to 0° C., more preferably −100° C. to 0° C., and further preferably −60° C. to 0° C.) while obtaining sufficient adhesiveness at ordinary temperature.

As used herein, the “alkyl (meth)acrylate ester having an alkyl group having 4 to 24 carbon atoms” is sometimes referred to as a “C₄₋₂₄ alkyl (meth)acrylate ester.”

The C₄₋₂₄ alkyl (meth)acrylate ester is not particularly limited, and examples thereof include n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, isopentadecyl (meth)acrylate, hexadecyl (meth)acrylate, isohexadecyl (meth)acrylate, heptadecyl (meth)acrylate, isoheptadecyl (meth)acrylate, octadecyl (meth)acrylate, isooctadecyl (meth)acrylate, docosyl (meth)acrylate, isodocosyl (meth)acrylate, tetracosyl (meth)acrylate, and isotetracosyl (meth)acrylate. The C₄₋₂₄ alkyl (meth)acrylate ester can be used alone, or two or more C₄₋₂₄ alkyl (meth)acrylate esters can be used in combination.

Specifically, as the C₄₋₂₄ alkyl (meth)acrylate ester, 2-ethylhexyl (meth)acrylate, decyl (meth)acrylate, isodecyl (meth)acrylate, undecyl (meth)acrylate, dodecyl (meth)acrylate, tridecyl (meth)acrylate, and isooctadecyl (meth)acrylate are more preferred, and 2-ethylhexyl acrylate and dodecyl acrylate (lauryl acrylate) are more preferred.

In addition, the acrylic polymer may comprise an alkyl (meth)acrylate ester having an alkyl group having 1 to 3 carbon atoms as a constituent monomer component. As used herein, the “alkyl (meth)acrylate ester having an alkyl group having 1 to 3 carbon atoms” is sometimes referred to as a “C₁₋₃ alkyl (meth)acrylate ester”.

The monomer components constituting the acrylic polymer may include only the alkyl (meth)acrylate ester having an alkyl group having 1 to 3 carbon atoms or may include the C₁₋₃ alkyl (meth)acrylate ester with the C₄₋₂₄ alkyl (meth)acrylate ester as the alkyl (meth)acrylate ester(s) having an alkyl group.

The C₁₋₃ alkyl (meth)acrylate ester is not particularly limited, and examples thereof include methyl (meth)acrylate, ethyl (meth)acrylate, propyl (meth)acrylate, and isopropyl (meth)acrylate. The C₁₋₃ alkyl (meth)acrylate ester can be used alone, or two or more C₁₋₃ alkyl (meth)acrylate esters can be used in combination.

The acrylic polymer may comprise, with the alkyl (meth)acrylate ester having an alkyl group such as the C₄₋₂₄ alkyl (meth)acrylate ester, a copolymerizable monomer copolymerizable with the alkyl (meth)acrylate ester as a constituent monomer component in terms of polymer design and the adjustment of the function of the pressure-sensitive adhesive layer (particularly, improvement in adhesive strength, and the function of inhibiting humidification cloudiness).

The copolymerizable monomer is not particularly limited, and examples thereof include alkyl (meth)acrylate esters having an alicyclic hydrocarbon group, polar group-containing monomers, and polyfunctional monomers.

As used herein, the “alkyl (meth)acrylate ester having an alicyclic hydrocarbon group” is sometimes referred to as an “alicyclic monomer”.

The copolymerizable monomer can be used alone, or two or more copolymerizable monomers can be used in combination.

The alicyclic monomers are monomers that are alicyclic compounds, that is, monomers having a non-aromatic ring in the molecule. Examples of the non-aromatic ring include non-aromatic alicyclic rings (cycloalkane rings such as a cyclopentane ring, a cyclohexane ring, a cycloheptane ring, and a cyclooctane ring; cycloalkene rings such as a cyclohexene ring; and the like) and non-aromatic bridged rings (for example, bridged hydrocarbon rings such as bicyclic hydrocarbon rings in pinane, pinene, bornane, norbornane, norbornene, and the like; and tricyclic hydrocarbon rings in adamantane and the like, and, in addition, tetracyclic hydrocarbon rings).

The alicyclic monomers are not particularly limited, and examples thereof include cycloalkyl (meth)acrylate esters such as cyclopentyl (meth)acrylate, cyclohexyl (meth)acrylate, cycloheptyl (meth)acrylate, and cyclooctyl (meth)acrylate; (meth)acrylates having a bicyclic hydrocarbon ring such as bornyl (meth)acrylate, isobornyl (meth)acrylate, dicyclopentanyl (meth)acrylate, and dicyclopentanyloxyethyl (meth)acrylate; and (meth)acrylates having a tri- or higher cyclic hydrocarbon ring such as tricyclopentanyl (meth)acrylate, 1-adamantyl (meth)acrylate, 2-methyl-2-adamantyl (meth)acrylate, and 2-ethyl-2-adamantyl (meth)acrylate. The alicyclic monomers can be used alone, or two or more of the alicyclic monomers can be used in combination.

Among them, cyclohexyl acrylate (CHA), cyclohexyl methacrylate (CRMA), isobornyl acrylate (IBXA), and isobornyl methacrylate (IBXMA) are preferred as the alicyclic monomers.

In addition, examples of the polar group-containing monomers include carboxyl group-containing monomers, hydroxyl group-containing monomers, amide group-containing monomers, amino group-containing monomers, epoxy group-containing monomers, cyano group-containing monomers, heterocycle-containing vinyl monomers, sulfonic acid group-containing monomers, imide group-containing monomers, phosphoric acid group-containing monomers, and isocyanate group-containing monomers. The polar group-containing monomers can be used alone, or two or more polar group-containing monomers can be used in combination.

Examples of the carboxyl group-containing monomers include acrylic acid (AA), methacrylic acid, itaconic acid, maleic acid, fumaric acid, and crotonic acid. In addition, examples thereof also include acid anhydrides of these carboxyl group-containing monomers (for example, acid anhydride group-containing monomers such as maleic anhydride and itaconic anhydride).

Examples of the hydroxyl group-containing monomers include hydroxyalkyl (meth)acrylates such as 2-hydroxyethyl (meth)acrylate, 3-hydroxypropyl (meth)acrylate, 4-hydroxybutyl (meth)acrylate, and 6-hydroxyhexyl (meth)acrylate, vinyl alcohol, and allyl alcohol.

Examples of the amide group-containing monomers include (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethyl(meth)acrylamide.

Examples of the amino group-containing monomers include aminoethyl (meth)acrylate, dimethylaminoethyl (meth)acrylate, and t-butylaminoethyl (meth)acrylate.

Examples of the epoxy group-containing monomers include glycidyl (meth)acrylate and methylglycidyl (meth)acrylate.

Examples of the cyano group-containing monomers include acrylonitrile and methacrylonitrile.

Examples of the heterocycle-containing vinyl monomers include N-vinyl-2-pyrrolidone, N-vinylcaprolactam, (meth)acryloylmorpholine, N-vinylpyridine, N-vinylpiperidone, N-vinylpyrimidine, N-vinyipiperazine, N-vinylpyrrole, N-vinylimidazole, and N-vinyloxazole.

Examples of the sulfonic acid group-containing monomers include sodium vinylsulfonate.

Examples of the phosphoric acid group-containing monomers include 2-hydroxyethylacryloyl phosphate.

Examples of the imide group-containing monomers include cyclohexylmaleimide and isopropylmaleimide.

Examples of the isocyanate group-containing monomers include 2-methacryloyloxyethyl isocyanate.

The acrylic polymer preferably comprises substantially no acidic group-containing monomer (particularly carboxyl group-containing monomer) as a constituent monomer component. This is because, depending on the material of the plate that is an object (adherend), the pressure-sensitive adhesive layer of the double-sided pressure-sensitive adhesive sheet may cause problems such as the corrosion of the plate and the modification of the plate surface, though the separation method of the present invention is a method of separating two plates laminated via a double-sided pressure-sensitive adhesive sheet. For example, when the material of a portion in the plate where the double-sided pressure-sensitive adhesive sheet is laminated is a metal (for example, a metal or a metal oxide), the pressure-sensitive adhesive layer of the double-sided pressure-sensitive adhesive sheet may cause corrosion.

“Comprising substantially no” means not actively blending except the case of unavoidable mixing, and specifically, the content of the acidic group-containing monomer (particularly the carboxyl group-containing monomer) in the monomer components constituting the acrylic polymer is preferably less than 0.05% by weight, more preferably less than 0.01% by weight, and further preferably less than 0.001% by weigh, based on the total amount (total weight, 100% by weight) of the constituent monomer components.

Further, the polyfunctional monomer as the copolymerizable monomer is not particularly limited, and examples thereof include hexanediol di(meth)acrylate (1,6-hexanediol di(meth)acrylate and the like), butanediol di(meth)acrylate, (poly)ethylene glycol di(meth)acrylate, (poly)propylene glycol di(meth)acrylate, neopentyl glycol di(meth)acrylate, pentaerythritol di(meth)acrylate (tetramethylolmethane tri(meth)acrylate), pentaerythritol tri(meth)acrylate, dipentaorythritol hexa(meth)acrylate, trimethylolpropane tri(meth)acrylate, allyl (meth)acrylate, vinyl (meth)acrylate, divinylbenzene, epoxy acrylates, polyester acrylates, and urethane acrylates. Among them, 1,6-hexanediol diacrylate (HDDA) is preferred. The polyfunctional monomer can be used alone, or two or more polyfunctional monomers can be used in combination.

Further, other examples of the copolymerizable monomer include (meth)acrylates having an aromatic hydrocarbon group such as phenyl (meth)acrylate, phenoxyethyl (meth)acrylate, and benzyl (meth)acrylate; alkoxyalkyl (meth)acrylate monomers such as methoxyethyl (meth)acrylate and ethoxyethyl (meth)acrylate, vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride. These monomers can be used alone, or two or more of these monomers can be used in combination.

When the double-sided pressure-sensitive adhesive sheet is a double-sided acrylic pressure-sensitive adhesive sheet, the proportion of the C₄₋₂₄ alkyl (meth)acrylate ester in the total amount (total weight, 100% by weight) of the monomer components constituting the acrylic polymer, in the acrylic polymer in the acrylic pressure-sensitive adhesive layer, is not particularly limited and is preferably not less than 45% by weight, more preferably not less than 50% by weight, and further preferably not less than 60% by weight, in terms of obtaining good reseparability at low temperature (for example, preferably −200° C. to 0° C., more preferably −100° C. to 0° C., and further preferably −60° C. to 0° C.) in the acrylic pressure-sensitive adhesive layer. When the reseparability of the double-sided pressure-sensitive adhesive sheet is good, the rework (reuse) of the plate separated by the method of separating plates according to the present invention can be more easily performed.

As used herein, the reseparability (removability) means “a property of being capable of being peeled without leaving a pressure-sensitive adhesive on an object surface when the pressure-sensitive adhesive sheet laminated on the object (adherend) is peeled”.

In addition, the upper limit of the proportion of the C₄₋₂₄ alkyl (meth)acrylate ester is not particularly limited and is more preferably not more than 95% by weight, further preferably not more than 90% by weight.

In addition, when the acrylic polymer comprises the C₁₋₃ alkyl (meth)acrylate ester as a constituent monomer component, the proportion of the C₁₋₃ alkyl (meth)acrylate ester in the total amount (total weight, 100% by weight) of the monomer components constituting the acrylic polymer is not particularly limited and is preferably more than 0% by weight and not more than 50% by weight in terms of obtaining a moderate elastic modulus to exhibit higher adhesive strength at ordinary temperature (on the order of 23° C.). The lower limit of the proportion of the C₁₋₃ alkyl (meth)acrylate ester is more preferably not less than 5% by weight, further preferably not less than 10% by weight. In addition, the upper limit of the proportion of the C₁₋₃ alkyl (meth)acrylate ester is preferably not more than 35% by weight, more preferably not more than 25% by weight.

Further, when the acrylic polymer comprises the alicyclic monomer as a constituent monomer component, the proportion of the alicyclic monomer in the total amount (total weight, 100% by weight) of the monomer components constituting the acrylic polymer is not particularly limited and is preferably more than 0% by weight and not more than 50% by weight in terms of obtaining a moderate elastic modulus to exhibit higher adhesive strength at ordinary temperature (on the order of 23° C.). The lower limit of the proportion of the alicyclic monomer is more preferably not less than 5% by weight, further preferably not less than 8% by weight, and still more preferably not less than 10% by weight. In addition, the upper limit of the proportion of the alicyclic monomer is preferably not more than 35% by weight, more preferably not more than 25% by weight, and still more preferably not more than 20% by weight.

Further, when the acrylic polymer comprises the polar group-containing monomer as a constituent monomer component, the proportion of the polar group-containing monomer in the total amount (total weight, 100% by weight) of the monomer components constituting the acrylic polymer is not particularly limited and is preferably more than 0% by weight and not more than 20% by weight in terms of inhibiting the adhesive strength of the acrylic pressure-sensitive adhesive layer from becoming too high over time to make the separation of the plates easy. For example, when a hydroxyl group-containing monomer and a nitrogen atom-containing monomer are contained as the polar group-containing monomers, the total content of both is preferably more than 0% by weight and not more than 20% by weight. The lower limit of the proportion of the polar group-containing monomer is more preferably not less than 2% by weight, further preferably not less than 3% by weight, and still more preferably not less than 10% by weight. In addition, the upper limit of the proportion of the polar group-containing monomer is preferably not more than 35% by weight, more preferably not more than 28% by weight, and still more preferably not more than 25% by weight.

Further, when the acrylic polymer comprises the polyfunctional monomer as a constituent monomer component, the proportion of the polyfunctional monomer in the total amount (total weight, 100% by weight) of the monomer components constituting the acrylic polymer is not particularly limited and is preferably more than 0% by weight and not more than 1% by weight in terms of controlling the gel fraction of the acrylic pressure-sensitive adhesive layer in a preferred range, and in terms of improving the height difference absorbency (height difference conformability, performance of filling height difference due to unevenness when a surface of the plate has unevenness) of the acrylic pressure-sensitive adhesive layer. The lower limit of the proportion of the polyfunctional monomer is more preferably not less than 0.02% by weight, further preferably not less than 0.03% by weight. In addition, the upper limit of the proportion of the polyfunctional monomer is preferably not more than 0.1% by weight, more preferably not more than 0.08% by weight.

The base polymer (for example, the acrylic polymer) can be obtained by polymerizing the monomer components by a known common polymerization method. Examples of the polymerization method include a solution polymerization method, an emulsion polymerization method, a bulk polymerization method, and polymerization methods by heat or active energy ray irradiation (a thermal polymerization method and an active energy ray polymerization method). Among them, the solution polymerization method and the active energy ray polymerization method are preferred in terms of workability and cost.

Examples of the active energy rays emitted in the active energy ray polymerization (photopolymerization) include ionizing radiation such as α-rays, β-rays, γ-rays, neutron beams, and electron beams and ultraviolet rays, and particularly, ultraviolet rays are preferred. In addition, the irradiation energy, irradiation time, irradiation method, and the like of the active energy rays are not particularly limited, and it is only necessary that the reaction of the monomer components can be caused.

In addition, various general solvents can be used in the solution polymerization. Examples of such solvents include organic solvents such as esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. The solvents can be used alone, or two or more of the solvents can be used in combination.

In the polymerization of the monomer components, a polymerization initiator such as a photopolymerization initiator (photoinitiator) or a thermal polymerization initiator can be used according to the type of the polymerization reaction. The polymerization initiator can be used alone, or two or more polymerization initiators can be used in combination.

The photopolymerization initiator is not particularly limited, and examples thereof include benzoin ether photopolymerization initiators, acetophenone photopolymerization initiators, α-ketol photopolymerization initiators, aromatic sulfonyl chloride photopolymerization initiators, photoactive oxime photopolymerization initiators, benzoin photopolymerization initiators, benzyl photopolymerization initiators, benzophenone photopolymerization initiators, ketal photopolymerization initiators, and thioxanthone photopolymerization initiators. The amount of the photopolymerization initiator used is not particularly limited and is preferably, for example, not less than 0.01 parts by weight and not more than 1 parts by weight based on 100 parts by weight of the total amount of the monomer components constituting the acrylic polymer. In addition, the lower limit of the amount of the photopolymerization initiator used is more preferably 0.05 parts by weight. Further, the upper limit of the amount of the photopolymerization initiator used is more preferably 0.5 parts by weight.

Examples of the benzoin ether photopolymerization initiators include benzoin methyl ether, benzoin ethyl ether, benzoin propyl ether, benzoin isopropyl ether, benzoin isobutyl ether, and 2,2-dimethoxy-1,2-diphenylethane-1-one. Examples of the acetophenone photopolymerization initiators include 2,2-diethoxyacetophenone, 2,2-dimethoxy-2-phenylacetophenone, 1-hydroxycyclohexyl phenyl ketone (α-hydroxycyclohexyl phenyl ketone), 4-phenoxydichloroacetophenone, and 4-(t-butyl)dichloroacetophenone. Examples of the α-ketol photopolymerization initiators include 2-methyl-2-hydroxypropiophenone and 1-[4-(2-hydroxyethyl)phenyl]-2-methylpropane-1-one. Examples of the aromatic sulfonyl chloride photopolymerization initiators include 2-naphthalenesulfonyl chloride. Examples of the photoactive oxime photopolymerization initiators include 1-phenyl-1,2-propanedione-2-(o-ethoxycarbonyl)-oxime. Examples of the benzoin photopolymerization initiators include benzoin. Examples of the benzyl photopolymerization initiators include benzyl. Examples of the benzophenone photopolymerization initiators include benzophenone, benzoylbenzoic acid, 3,3′-dimethyl-4-methoxybenzophenone, and polyvinylbenzophenone. Examples of the ketal photopolymerization initiators include benzyl dimethyl ketal. Examples of the thioxanthone photopolymerization initiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Examples of the polymerization initiator used in polymerization by the solution polymerization include azo polymerization initiators, peroxide polymerization initiators (for example, dibenzoyl peroxide and tert-butyl permaleate), and redox polymerization initiators. Among them, azo polymerization initiators disclosed in Japanese Patent Laid-Open No. 2002-69411 are preferred. Examples of the azo polymerization initiators include 2,2′-azobisisobutyronitrile, 2,2′-azobis-2-methylbutyronitrile, dimethyl 2,2′-azobis(2-methylpropionate), and 4,4′-azobis-4-cyanovaleric acid. The amount of the azo polymerization initiator used is preferably not less than 0.05 parts by weight to not more than 0.5 parts by weight based on 100 parts by weight of the total amount of the monomer components constituting the acrylic polymer. In addition, the lower limit of the amount of the azo polymerization initiator used is more preferably 0.1 parts by weight. Further, the upper limit of the amount of the azo polymerization initiator used is more preferably 0.3 parts by weight.

As described above, the pressure-sensitive adhesive layer in the double-sided pressure-sensitive adhesive sheet is formed of a pressure-sensitive adhesive composition. Additives may be contained in the pressure-sensitive adhesive composition as required. Examples of the additives include crosslinking agents, crosslinking accelerators, tackifier resins (rosin derivatives, polyterpene resins, petroleum resins, oil-soluble phenols, and the like), anti-aging agents, fillers, coloring agents (pigments, dyes, and the like), ultraviolet absorbing agents, antioxidants, chain transfer agents, plasticizers, softening agents, surfactants, and antistatic agents. The additives can be used alone, or two or more additives can be used in combination.

The crosslinking agents are not particularly limited, and examples thereof include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents and epoxy crosslinking agents are preferred. The crosslinking agents can be used alone, or two or more of the crosslinking agents can be used in combination.

Examples of the isocyanate crosslinking agents (polyfunctional isocyanate compounds) include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; and aromatic polyisocyanates such as 2,4-tolylene diisocyanate, 2,6-tolylene diisocyanate, 4,4′-diphenylmethane diisocyanate, and xylylene diisocyanate.

Other examples include a trimethylolpropane/tolylene diisocyanate adduct (trade name “CORONATE L,” manufactured by NIPPON POLYURETHANE INDUSTRY CO., LTD.) and a trimethylolpropane/hexamethylene diisocyanate adduct (trade name “CORONATE IL,” manufactured by NIPPON POLYURETHANE INDUSTRY CO., LTD.).

In addition, examples of the epoxy crosslinking agents (polyfunctional epoxy compounds) include N,N,N′,N′-tetraglycidyl-m-xylenediamine, diglycidylaniline, 1,3-bis(N,N-diglycidylaminomethyl) cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, diglycidyl adipate ester, diglycidyl o-phthalate ester, triglycidyl-tris(2-hydroxyethyl) isocyanurate, resorcin diglycidyl ether, and bisphenol-S-diglycidyl ether, and, in addition, epoxy resins having two or more epoxy groups in the molecule. Other examples include commercial products such as the trade name “TETRAD-C” (manufactured by MITSUBISHI GAS CHEMICAL COMPANY, INC.).

The content of the crosslinking agent is not particularly limited and is preferably not less than 0.001 parts by weight and not more than 10 part by weight based on 100 parts by weight of the total amount of the constituent monomer components in terms of controlling the gel fraction of the pressure-sensitive adhesive layer formed of the pressure-sensitive adhesive composition in a preferred range. In addition, the lower limit of the content of the crosslinking agent is more preferably 0.01 parts by weight. Further, the upper limit of the content of the crosslinking agent is more preferably 3 parts by weight.

In addition, a solvent may be contained in the pressure-sensitive adhesive composition. The solvent is not particularly limited, and examples thereof include organic solvents such as esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. The solvent can be used alone, or two or more of the solvents can be used in combination.

The pressure-sensitive adhesive composition can be obtained by a known or common preparation method though it is not particularly limited. For example, the solvent type pressure-sensitive adhesive composition can be obtained by mixing a base polymer, additives, a solvent, and the like. In addition, the active energy ray curing type pressure-sensitive adhesive composition can be obtained by mixing a monomer mixture or a partial polymer thereof, additives, a photopolymerization initiator, and the like.

The pressure-sensitive adhesive layer in the double-sided pressure-sensitive adhesive sheet can be formed by a known or common method using the pressure-sensitive adhesive composition. For example, when the solvent type pressure-sensitive adhesive composition is used, the pressure-sensitive adhesive layer can be formed by applying the pressure-sensitive adhesive composition in the form of a layer to obtain an applied layer, and heating and drying the applied layer. In addition, when the active energy ray curing type pressure-sensitive adhesive composition is used, the pressure-sensitive adhesive layer can be formed by applying the pressure-sensitive adhesive composition in the form of a layer to obtain an applied layer, and irradiating the applied layer with active energy rays. After the irradiation with active energy rays, heating and drying may be performed as required.

The thickness of the pressure-sensitive adhesive layer in the double-sided pressure-sensitive adhesive sheet is not particularly limited and is preferably not less than 10 μm and not more than 1 mm. The upper limit of the thickness of the pressure-sensitive adhesive layer is more preferably 500 μm, further preferably 350 μm. In a case where the thickness of the pressure-sensitive adhesive layer is not less than 10 μm, when there is unevenness on the plate surface, the pressure-sensitive adhesive layer is likely to conform to the height difference portion due to the unevenness. In other words, the height difference absorbency of the pressure-sensitive adhesive layer is likely to be improved. In addition, when the thickness of the pressure-sensitive adhesive layer is not more than 1 mm, the deformation of the pressure-sensitive adhesive layer is less likely to occur, and the processability is likely to be improved.

The gel fraction of the pressure-sensitive adhesive layer in the double-sided pressure-sensitive adhesive sheet is not particularly limited and is preferably not less than 20% by weight and not more than 90% by weight. The lower limit of the gel fraction of the pressure-sensitive adhesive layer is more preferably 30% by weight, further preferably 40% by weight. In addition, the upper limit of the gel fraction of the pressure-sensitive adhesive layer is more preferably 85% by weight, further preferably 80% by weight. When the gel fraction is not more than 90% by weight, the cohesion of the pressure-sensitive adhesive layer decreases to some extent, and the pressure-sensitive adhesive layer becomes soft, and therefore, when there is unevenness on the plate surface, the pressure-sensitive adhesive layer is likely to conform to the height difference portion due to the unevenness. In other words, the height difference absorbency of the pressure-sensitive adhesive layer is likely to be improved. In addition, when the gel fraction is not less than 20% by weight, sufficient strength is likely to be obtained in the pressure-sensitive adhesive layer, and good processability is likely to be obtained in the pressure-sensitive adhesive sheet. In addition, good foaming and peeling resistance (resistance to peeling due to foaming) is likely to be obtained. The gel fraction can be controlled by the type and content (amount used) of the polyfunctional monomer and/or the crosslinking agent, and the like.

The gel fraction (the proportion of solvent-insoluble matter) can be determined as ethyl acetate-insoluble matter. Specifically, it is determined as the weight ratio (unit: % by weight) of insoluble matter after the pressure-sensitive adhesive layer is immersed in ethyl acetate at room temperature (23° C.) for 7 days, to the sample before the immersion. More specifically, the gel fraction is a value calculated by the following “method of measuring the gel fraction”.

### (Method of Measuring Gel Fraction)

About 1 g of the pressure-sensitive adhesive layer is taken, and its weight is measured and taken as “the weight of the pressure-sensitive adhesive layer before immersion”. Next, the taken pressure-sensitive adhesive layer is immersed in 40 g of ethyl acetate for 7 days, and then, all components insoluble in the ethyl acetate (insoluble portions) are recovered. All the recovered insoluble portions are dried at 130° C. for 2 hours to remove the ethyl acetate, and then, their weight is measured and taken as “the dry weight of the insoluble portions” (the weight of the pressure-sensitive adhesive layer after immersion). Then, the obtained numerical value is substituted into the following formula for calculation.

the gel fraction (% by weight)=[(the dry weight of the insoluble portions)/(the weight of the pressure-sensitive adhesive layer before immersion)]×100

### (Plates)

The method of separating plates according to the present invention is a method of separating two plates laminated via the double-sided pressure-sensitive adhesive sheet, and such plates are not particularly limited. Examples thereof include glass plates; plates composed of plastics such as acrylic resins, polycarbonates, and polyethylene terephthalate (plastic plates); plates composed of metals such as stainless steel and aluminum (metal plates); or plates composed of combinations thereof (for example, plates in which a plastic plate surface is coated with a metal, a metal oxide, or the like). In addition, the plates may be single-layer materials or laminates.

As used herein, the concept of the plates includes films and sheets.

In the method of separating plates according to the present invention, the two plates laminated via the double-sided pressure-sensitive adhesive sheet may be the same plates or different plates. In addition, the sizes of the two plates laminated via the double-sided pressure-sensitive adhesive sheet (the areas of the plates) may be the same or different.

Further, according to the method of separating plates according to the present invention, the two plates laminated via the pressure-sensitive adhesive sheet can be separated smoothly, efficiently, and accurately without such force (load) that large strain (deformation) leading to breakage or cracking occurs being substantially applied to the plates, and therefore, the rigidity of the plates and the thickness of the plates are also not particularly limited. Therefore, the plates may be plates having high rigidity, for example, plastic plates having high rigidity or glass plates having high rigidity, or may be plates having low rigidity or soft plates. In addition, the plates may be plates having small thickness, thin film-like plates, or may be plates having large thickness.

Further, according to the method of separating plates according to the present invention, such force (load) that large strain (deformation) leading to breakage or cracking occurs is not substantially applied to the plates during the separation of the two plates. Therefore, the separated plate can be preferably reworked (reused).

Accordingly, preferred examples of the plates also include optical members for which the demand for reworkability is high. As the optical members, members having optical properties (for example, polarization properties, light refractivity, light scattering properties, light reflectivity, light transmission properties, light absorption properties, light diffraction properties, optical rotatory power, and visibility) are preferred. Examples of the members having optical properties include members (plates) constituting optical products such as displays (image displays) and input apparatuses, for example, polarizing plates, wave plates, phase difference plates, optical compensation films, brightness enhancement films, light guide plates, reflective films, antireflection films, transparent conductive films (ITO films and the like), design films, decorative films, surface protection plates, prisms, lenses, color filters, and transparent substrates, and further, members (plates) in which these are Laminated. The “optical members” also include members having the role of decoration or protection while keeping the visibility of displays or input apparatuses that are objects (design films, decorative films, surface protection plates, and the like) as described above.

Examples of the displays (image displays) include liquid crystal displays, organic EL (electroluminescent) displays, PDPs (plasma display panels), and electronic paper. In addition, examples of the input apparatuses include touch panels.

Among them, the optical members as the plates may be high rigidity optical members. Particularly, the optical members may be optical members composed of glass. Specific examples include plates having optical properties composed of glass such as glass sensors, display panels made of glass (LCDs and the like), and glass plates with transparent electrodes in touch panels. Particular examples include glass sensors and display panels made of glass.

The areas of the plates are not particularly limited and are each preferably more than 0 and not more than 20000 cm². The lower limits of the areas of the plates are each more preferably not less than 1 cm², further preferably not less than 5 cm², still more preferably not less than 10 cm², and most preferably not less than 20 cm². In addition, the upper limits of the areas of the plates are each more preferably not more than 15000 cm², further preferably not more than 10000 cm², still more preferably not more than 800 cm², and most preferably not more than 500 cm². The areas of the two laminated plates may be the same or different.

The thicknesses of the plates are not particularly limited and are each preferably not less than 0.1 mm and not more than 5 mm. The lower limits of the thicknesses of the plates are each more preferably 0.3 mm, further preferably 0.5 mm. In addition, the upper limits of the thicknesses of the plates are each more preferably 3 mm, further preferably 2 mm. For the plates, it is preferred that the thickness of at least one plate satisfy the above range. The thicknesses of the two laminated plates may be the same or different. According to the method of separating plates according to the present invention, even such thin plates that cannot be peel-separated (peeled and separated) can be separated without such force (load) that large strain (deformation) leading to breakage or cracking occurs being substantially applied, and therefore, for example, even plastic plates or glass plates having high rigidity and being thin films (for example, having a thickness of not more than 1 mm) can be separated without causing problems such as breakage and cracking.

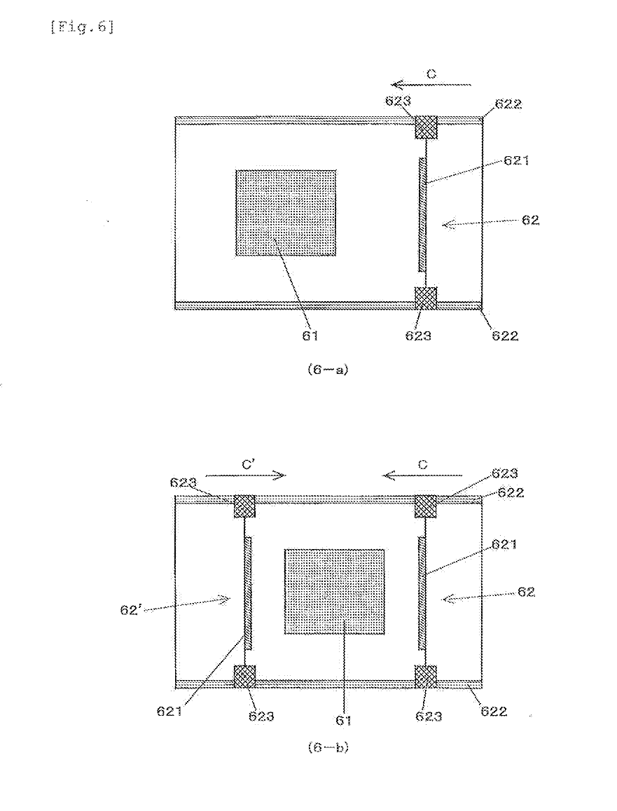

One example of a case where the method of separating plates according to the present invention is applied to optical members will be described using FIG. 5. The specific example of the case where the method of separating plates according to the present invention is applied to optical members is not limited to the example shown in FIG. 5. FIG. 5 shows schematic views showing a series of flows. Each figure in FIG. 5 is a side view.

In FIG. 5, (5-a) shows a state before the method of separating plates according to the present invention is carried out, (5-b′) and (5-b″) show a state in which the method of separating plates according to the present invention is carried out, and (5-c) shows a state after the method of separating plates according to the present invention is carried out. In FIG. 5, reference numeral 5 denotes a display, reference numeral 51 denotes a display panel (liquid crystal display, LCD), reference numeral 52 denotes a double-sided pressure-sensitive adhesive sheet, reference numeral 53 denotes a touch sensor, reference numeral 54 denotes an adhesive layer, and reference numeral 55 denotes a glass plate (glass substrate or glass lens). In addition, a denotes the normal direction of the display and the thickness direction of the display. Further, b denotes the horizontal direction and the surface direction (plane direction) of the display. The display panel 51 may be a type with a polarizing plate (for example, an LCD with a polarizing plate).

In (5-a) in FIG. 5, the cutting tool a (2) is positioned so as to touch between the double-sided pressure-sensitive adhesive sheet 52 and the display panel 51 on a side of the display 5 when the cutting tool a is placed on the display 5.

In (5-b′) and (5-b″) in FIG. 5, the cutting tool a (2) is placed in the horizontal direction between the double-sided pressure-sensitive adhesive sheet 52 and the display panel 51 on the side of the display 5, and force is applied to the cutting tool a (2). By this force in the horizontal direction applied to the cutting tool a (2), the cutting tool a (2) is inserted at the interface between the double-sided pressure-sensitive adhesive sheet 52 and the display panel 51, and the cutting tool a (2) moves in the horizontal direction (plane direction) between the double-sided pressure-sensitive adhesive sheet 52 and the display panel 51. Then, because the cutting tool a (2) Is inserted at the interface between the double-sided pressure-sensitive adhesive sheet 52 and the display panel 51 and moves in the horizontal direction between the double-sided pressure-sensitive adhesive sheet 52 and the display panel 51, force acts on the display panel 51 in the normal direction a, and separation occurs between the display panel 51 and the double-sided pressure-sensitive adhesive sheet 52.

(5-b′) and (5-b″) in FIG. 5 show that cutting tool a (2) is inserted at the interface between the double-sided pressure-sensitive adhesive sheet 52 and the display panel 51, and separation occurs between the display panel 51 and the double-sided pressure-sensitive adhesive sheet 52. When the rigidity of the display panel 51 is high, there is a tendency that only by separating part of the adhesive face between the double-sided pressure-sensitive adhesive sheet 52 and the display panel 51, separation occurs serially, which is triggered by the separated part, as shown in (5-b′). In such a case, even if the movement distance of the cutting tool a (2) in the horizontal direction is short, perfect separation may occur between the double-sided pressure-sensitive adhesive sheet 52 and the display panel 51. In addition, when the flexibility of the display panel 51 is high, there is a tendency that even if part of the adhesive face between the double-sided pressure-sensitive adhesive sheet 52 and the display panel 51 is separated, serial separation triggered by the separated place is less likely to occur, as shown in (5-b″). In such a case, it is preferred that the cutting tool a (2) be moved in the horizontal direction from one end to the other end of the display 5 to cause perfect separation between the double-sided pressure-sensitive adhesive sheet 52 and the display panel 51.

In (5-c) in FIG. 5, force acts on the display panel 51 in the normal direction a to cause separation between the display panel 51 and the double-sided pressure-sensitive adhesive sheet 52, and the display panel 51 is separated. In other words, in (5-c) in FIG. 5, the display 5 is separated into “the display panel 51” and “a structure composed of the touch sensor 53, the adhesive layer 54, and the glass plate 55”. The separated “display panel 51” can be preferably reworked (reused) because such force (load) that large strain (deformation) leading to breakage or cracking occurs is not substantially applied during the separation.

### [Apparatus for Separating Plates]

An apparatus for separating plates according to the present invention is an apparatus for separating two plates laminated via a double-sided pressure-sensitive adhesive sheet, comprising a cutting tool having a cutting edge angle of not more than 25° and a thickness of not more than 20 mm, and being capable of placing the cutting tool on a side of a structure composed of a double-sided pressure-sensitive adhesive sheet and two plates between the double-sided pressure-sensitive adhesive sheet and the plate and applying force in the normal direction of the plate.

The apparatus for separating plates according to the present invention can separate the two plates laminated via the pressure-sensitive adhesive sheet, smoothly, efficiently, and accurately without such force (load) that large strain (deformation) leading to breakage or cracking occurs being substantially applied to the plates. According to the apparatus for separating plates according to the present invention, the method of separating plates according to the present invention described above can be carried out accurately and efficiently. In addition, problems regarding the separation of plates due to human factors such as variations in the degree of skill from worker to worker (variations in the extent of separation, and the like) can be inhibited.

The apparatus for separating plates according to the present invention has at least a cutting tool having a cutting edge angle of not more than 25° and a thickness of not more than 20 mm (the cutting tool a). The apparatus for separating plates according to the present invention has the cutting tool a and therefore can inhibit at a higher level, for the two plates laminated via the pressure-sensitive adhesive sheet, the substantial application of such force that large strain leading to breakage or cracking occurs, to the plates, to separate the two plates smoothly, efficiently, and accurately.

The target to which the apparatus for separating plates according to the present invention is applied is the structure composed of the two plates laminated via the double-sided pressure-sensitive adhesive sheet (the structure composed of the double-sided pressure-sensitive adhesive sheet and the two plates, the structure a), and the double-sided pressure-sensitive adhesive sheet in such a structure is not particularly limited and is preferably the double-sided pressure-sensitive adhesive sheet.

The apparatus for separating plates according to the present invention preferably has at least a mechanism that can place the cutting tool, on a side of the structure composed of the double-sided pressure-sensitive adhesive sheet and the two plates, between the double-sided pressure-sensitive adhesive sheet and the plate and apply force in the normal direction of the plate. In addition, the apparatus for separating plates according to the present invention preferably has a base (workbench) on which the structure can be horizontally mounted.

The mechanism that can place the cutting tool a between the double-sided pressure-sensitive adhesive sheet and the plate on a side of the structure a is not particularly limited as long as it is a mechanism that can place the cutting tool a at the desired position on a side of the structure a so that force can be applied in the normal direction of the plate, and examples thereof include (a) a mechanism that can move in the thickness direction (height direction) of the structure a that is the target to which the apparatus for separating plates according to the present invention is applied, (b) a mechanism in which the cutting tool a can move in the thickness direction (height direction) of the structure a, and a mechanism having both the mechanism (a) and the mechanism (b). Examples of the mechanism (a) include a mechanism in which a gap (height difference, hole, recess, or the like) is provided in the base in the apparatus for separating plates, and by embedding the structure a in this gap, the structure a can be moved in the thickness direction to place the cutting tool a at the desired position on a side of the structure a. The height of the gap is a certain size and may be adjusted by inserting a spacer into the gap.

In addition, the mechanism that can apply force in the normal direction of the plate in the apparatus for separating plates according to the present invention is not particularly limited, and examples thereof include (c) a mechanism in which the structure a moves in the horizontal direction, and the structure a touches the cutting tool a, and thus, force is applied in the normal direction of the plate, (d) a mechanism in which the cutting tool a moves in the horizontal direction, and the cutting tool a touches the structure a, and thus, force is applied in the normal direction of the plate, and a mechanism having both the mechanism (c) and the mechanism (d).

The mechanism that can apply force in the normal direction of the plate is not particularly limited, and more specific examples include a mechanism that can place the cutting tools a on four corners of the structure a or four sides of the structure a, move the cutting tools a in the horizontal direction, and apply force in the normal direction of the plate; a mechanism that can place the cutting tools on two opposite sides of the structure a, move the cutting tools a in the horizontal direction, and apply force in the normal direction of the plate; and a mechanism that can place the cutting tool on any one side of the structure a or any one corner of the structure a, move the cutting tool a in the horizontal direction, and apply force in the normal direction of the plate.

The apparatus for separating plates according to the present invention preferably operates even at a temperature that is a temperature at which the storage modulus of the pressure-sensitive adhesive layer of the double-sided pressure-sensitive adhesive sheet measured by dynamic viscoelasticity measurement is not less than 1.0×10⁷ Pa. For example, the apparatus for separating plates according to the present invention preferably operates even at low temperature (for example, preferably −200° C. to 0° C., more preferably −100° C. to 0° C., and further preferably −60° C. to 0° C.). This is because as described above, the double-sided pressure-sensitive adhesive sheet used for the lamination of the two plates is preferably the double-sided pressure-sensitive adhesive sheet, and as the double-sided pressure-sensitive adhesive sheet, a double-sided pressure-sensitive adhesive sheet having a pressure-sensitive adhesive layer having the storage modulus measured by dynamic viscoelasticity measurement of not less than 1.0×10⁷ Pa at low temperature (for example, preferably −200° C. to 0° C., more preferably −100° C. to 0° C., and further preferably −60 to 0° C.) is preferably used.

In the apparatus for separating plates according to the present invention, as the materials, those in which volume change (dimensional change), changes in properties, or the like do not occur even at low temperature are preferably used in terms of operability at the above low temperature. For example, the workbench, the cutting tool, and the like may be composed of stainless steel. In addition, the mechanism for smoothly moving the mechanism (for example, a guide rail for smoothly moving the mechanism that can apply force in the normal direction of the plate) and the like may be composed of ultra-high molecular polyethylene.

Further, in the apparatus for separating plates according to the present invention, a material which is lubricating oil (grease) and in which modification does not occur even at low temperature may be used in a range that does not adversely affect the work of the separation of the two plates or the plates after separation, in order to smoothly operate each mechanism.

Further, the apparatus for separating plates according to the present invention may have a cooling mechanism in order to obtain the low temperature.

One example of the apparatus for separating plates according to the present invention will be described below using FIG. 6. The apparatus for separating plates according to the present invention is not limited to the apparatus shown in FIG. 6. Each figure in FIG. 6 is a top view.

In FIG. 6, (6-a) and (6-b) each show a state in which the structure a is fixed on the base of the apparatus for separating plates according to the present invention. The apparatus for separating plates shown in (6-a) has one “mechanism that can place the cutting tool a between the double-sided pressure-sensitive adhesive sheet and the plate on a side of the structure a and apply force in the normal direction of the plate,” and the apparatus for separating plates shown in (6-b) has two of the mechanisms. In FIG. 6, reference numeral 61 denotes the structure a, and reference numerals 62 and 62′ each denote the “mechanism that can place the cutting tool a between the double-sided pressure-sensitive adhesive sheet and the plate on a side of the structure a and apply force in the normal direction of the plate”. In addition, reference numeral 621 denotes the cutting tool a, reference numeral 622 denotes a guide rail, and reference numeral 623 denotes a gear. Further, the direction C is the direction in which the mechanism 62 moves, and the direction C′ is the direction in which the mechanism 62′ moves. The apparatus for separating plates in FIG. 6 has a base on which the structure a can be horizontally mounted.

### EXAMPLES

The present invention will be described below in more detail based on examples, but the present invention is not limited by these examples.

### (Pressure-Sensitive Adhesive Composition Preparation Example 1)

68 Parts by weight of 2-ethylhexyl acrylate (2EHA), 14.5 parts by weight of N-vinyl-2-pyrrolidore (NVP), and 17.5 parts by weight of hydroxyethyl acrylate (HEA) were introduced into a four-necked flask and mixed to obtain a monomer mixture.

Next, 0.05 parts by weight of 1-hydroxy-cyclohexyl-phenyl-ketone (trade name “IRGACURE 184,” manufactured by BASF Japan) and 0.05 parts by weight of 2,2-dimethoxy-1,2-diphenylethane-1-one (trade name “IRGACURE 651,” manufactured by BASF Japan) as photopolymerization initiators were introduced into the monomer mixture, and the mixture was irradiated with ultraviolet rays under a nitrogen atmosphere until the viscosity (BH viscometer No. 5 rotor, 10 rpm, temperature 30° C.) reached about 15 Pa·s, for photopolymerization, to obtain a partially polymerized monomer syrup (a partial polymer of the monomer components).

Further, 0.05 parts by weight of 1,6-hexanediol diacrylate (HDDA, polyfunctional monomer), 0.05 parts by weight of 1-hydroxy-cyclohexyl-phenyl-ketone (trade name “IRGACURE 184,” manufactured by BASF Japan) as a photopolymerization initiator (additional initiator), and 0.05 parts by weight of 2,2-dimethoxy-1,2-diphenylethane-1-one (trade name “IRGACURE 651,” manufactured by BASF Japan) as a photopolymerization initiator (additional initiator) were introduced into 100 parts by weight of the partially polymerized monomer syrup and uniformly mixed to obtain a pressure-sensitive adhesive composition.

The obtained pressure-sensitive adhesive composition was taken as a “pressure-sensitive adhesive composition A”.

### (Pressure-Sensitive Adhesive Composition Preparation Example 2)

40.5 Parts by weight of 2-ethylhexyl acrylate (2EHA), 40.5 parts by weight of isostearyl acrylate (ISA), 18 parts by weight of N-vinyl-2-pyrrolidone (NVP), and 1 part by weight of 4-hydroxybutyl acrylate (4HBA) were introduced into a four-necked flask and mixed to obtain a monomer mixture.

A pressure-sensitive adhesive composition was obtained as in Pressure-Sensitive Adhesive Composition Preparation Example 1 except that the monomer mixture was used.

The obtained pressure-sensitive adhesive composition was taken as a “pressure-sensitive adhesive composition B.”

### (Pressure-Sensitive Adhesive Composition Preparation Example 3)

73 Parts by weight of lauryl acrylate (LA), 21 parts by weight of N-vinyl-2-pyrrolidone (NVP), and 6 parts by weight of hydroxyethyl acrylate (HEA) were introduced into a four-necked flask and mixed to obtain a monomer mixture.

A pressure-sensitive adhesive composition was obtained as in Pressure-Sensitive Adhesive Composition Preparation Example 1 except that the monomer mixture was used.

The obtained pressure-sensitive adhesive composition was taken as a “pressure-sensitive adhesive composition C”.

### (Pressure-Sensitive Adhesive Composition Preparation Example 4)

60 Parts by weight of lauryl acrylate (LA), 22 parts by weight of 2-ethylhexyl acrylate (2EHA), 10 parts by weight of N-vinyl-2-pyrrolidone (NVP), and 8 parts by weight of 4-hydroxybutyl acrylate (4HBA) were Introduced into a four-necked flask and mixed to obtain a monomer mixture.

A pressure-sensitive adhesive composition was obtained as in Pressure-Sensitive Adhesive Composition Preparation Example 1 except that the monomer mixture was used.

The obtained pressure-sensitive adhesive composition was taken as a “pressure-sensitive adhesive composition D”.

### (Release Film Use Example 1)

As the release film, a release film (trade name “MRF#38”, manufactured by Mitsubishi Plastics, Inc.) was used. This release film was taken as a “release film A”.

### (Release Film Use Example 2)

As the release film, a release film (trade name “MRN#38”, manufactured by Mitsubishi Plastics, Inc.) was used. This release film was taken as a “release film B”.

### Example 1

The pressure-sensitive adhesive composition A was applied to the release-treated face of the release film A to form a pressure-sensitive adhesive composition layer. Next, the release film B was laminated on the formed pressure-sensitive adhesive composition layer in a form in which the release-treated face was in contact with the pressure-sensitive adhesive composition layer. Then, ultraviolet irradiation was performed under the conditions of illuminance 4 mW/cm² and the amount of light 1200 mJ/cm² to photocure the pressure-sensitive adhesive composition layer to produce a double-sided pressure-sensitive adhesive sheet composed of only a pressure-sensitive adhesive layer having a thickness of 250 μm. The adhesive faces of the double-sided pressure-sensitive adhesive sheet were protected by the release film A and the release film B. This obtained double-sided pressure-sensitive adhesive sheet was taken as a “double-sided pressure-sensitive adhesive sheet A”.

Next, a sheet piece (size: length 100 mm, width 50 mm) was cut from the double-sided pressure-sensitive adhesive sheet A. The release film B was peeled from the cut sheet piece, and a glass plate (manufactured by MATSUNAMI GLASS IND., LTD., thickness 0.7 mm, size: length 100 mm, width 50 mm, glass plate (a)) was laminated on the exposed adhesive face. Further, the release film A was peeled, and a glass plate (manufactured by MATSUNAMI GLASS IND., LTD., thickness 0.7 mm, size: length 100 mm, width 50 mm, glass plate (b)) was laminated on the exposed adhesive face. Then, a structure in which the glass plate (a), the double-sided pressure-sensitive adhesive sheet A, and the glass plate (b) were laminated in this order was obtained. This obtained structure was taken as a “glass structure A”.

In addition, a sheet piece (size: length 100 mm, width 50 mm) was cut from the double-sided pressure-sensitive adhesive sheet A. The release film B was peeled from the cut sheet piece, and a module 1 (a structure having a structure in which a glass plate (glass lens), an adhesive layer, and a touch sensor were laminated in this order) was laminated on the exposed adhesive face with the adhesive face being in contact with the touch sensor. Further, the release film A was peeled, and an LCD panel (display panel) was laminated on the exposed adhesive face. Then, a structure in which the module 1, the double-sided pressure-sensitive adhesive sheet A, and the display panel were laminated in this order was obtained. This obtained structure was taken as an “LCD structure A”.

Next, the glass structure A and the LCD structure A were introduced into an autoclave and autoclave-treated under the conditions of a pressure of 5 atm and a temperature of 50° C. for 15 minutes. After the autoclave treatment, the glass structure A and the LCD structure A were removed from the autoclave and allowed to stand under a temperature atmosphere of −40° C. for 1 hour.

After the standing, the following separation method A was carried out under a temperature condition of −40° C. for each of the glass structure A and the LCD structure A.

Then, the state after the separation method A was carried out was checked, and evaluation was performed according to the following criteria.

### (The Application of the Separation Method A to the Glass Structure)

Good (∘): Cracking or breakage of the glass plate(s) does not occur.

Poor (x): Cracking or breakage of the glass plate(s) occurs.

### (The Application of the Separation Method A to the LCD Structure)

Good (∘): Cracking or breakage does not occur in the LCD panel and the touch sensor.

Poor (x): Cracking or breakage occurs in at least one of the LCD panel and the touch sensor.

In Example 1, the evaluation result of Good was obtained for the application of the separation method A to the glass structure, and the evaluation result of Good was obtained for the application of the separation method A to the LCD structure.

In all of cases where cutting tools (i) were used and cases where cutting tools (ii) were used, the evaluation result of Good was obtained.

### (Separation Method A)

The separation of plates laminated via a double-sided pressure-sensitive adhesive sheet was performed using an apparatus for separating plates.

The apparatus for separating plates has two cutting tools and has two mechanisms in each of which the cutting tool moves in the horizontal direction, the cutting tool touches a structure, the cutting tool moves inside the structure, and thus, force is applied in the normal direction of the structure. These mechanisms are opposite in the apparatus for separating plates and can place the cutting tools on two opposite sides of the structure, respectively. (6-b) in FIG. 6 corresponds to a schematic top view of the apparatus for separating plates.

In the apparatus for separating plates, the following cutting tools (i) or (ii) were used. Cutting tools of the same type were used for one cutting tool and the other cutting tool. For example, when a cutting tool (i) was used for one cutting tool, another cutting tool (i) was also used for the other cutting tool.

Cutting tool (i): a cutting tool in which the angle of the cutting edge is 140, the thickness of the blade is 3 mm, the blade shape is a triangular blade shape (see FIG. 4), and the angle of the tip of the triangular blade is 165° (corresponding to the angle p in FIG. 4)

Cutting tool (ii): a cutting tool in which the angle of the cutting edge is 10°, the thickness of the blade is 3 mm, the blade shape is a triangular blade shape (see FIG. 4), and the angle of the tip of the triangular blade is 165° (corresponding to the angle p in FIG. 4)

In addition, in the apparatus for separating plates, a gap whose height can be adjusted is provided in the workbench (base), and therefore, the cutting tools can be placed at the desired positions on sides of the structure.

In the separation method A, the cutting tools are placed between the glass plate (a) and the double-sided pressure-sensitive adhesive sheet on sides of the glass structure, and the cutting tools are placed between the display panel and the double-sided pressure-sensitive adhesive sheet on sides of the LCD structure.

### Example 2

A double-sided pressure-sensitive adhesive sheet composed of only a pressure-sensitive adhesive layer having a thickness of 250 μm was produced as in Example 1 except that the pressure-sensitive adhesive composition B was used instead of the pressure-sensitive adhesive composition A. This obtained double-sided pressure-sensitive adhesive sheet was taken as a “double-sided pressure-sensitive adhesive sheet B”.

Next, using the double-sided pressure-sensitive adhesive sheet B, a structure having a structure in which the glass plate (a), the double-sided pressure-sensitive adhesive sheet B, and the glass plate (b) were laminated in this order (glass structure) was obtained as in Example 1. This obtained structure was taken as a “glass structure B”.

In addition, using the double-sided pressure-sensitive adhesive sheet B, a structure having a structure in which the module 1, the double-sided pressure-sensitive adhesive sheet B, and a display panel were laminated in this order (LCD structure) was obtained as in Example 1. This obtained structure was taken as an “LCD structure B”.

Next, the glass structure B and the LCD structure B were introduced into an autoclave and autoclave-treated under the conditions of a pressure of 5 atm and a temperature of 50° C. for 15 minutes. After the autoclave treatment, the glass structure B and the LCD structure B were removed from the autoclave and allowed to stand under a temperature atmosphere of −40° C. for 1 hour.

After the standing, the separation method A was carried out under a temperature condition of −40° C. for each of the glass structure B and the LCD structure B. Then, the state after the separation method A was carried out was checked, and evaluation was performed according to the same criteria in Example 1.

In Example 2, the evaluation result of Good was obtained for the application of the separation method A to the glass structure, and the evaluation result of Good was obtained for the application of the separation method A to the LCD structure.

In all of cases where the cutting tools (i) were used and cases where the cutting tools (ii) were used, the evaluation result of Good was obtained.

### Example 3

A double-sided pressure-sensitive adhesive sheet composed of only a pressure-sensitive adhesive layer having a thickness of 150 μm was produced as in Example 1 except that the pressure-sensitive adhesive composition C was used instead of the pressure-sensitive adhesive composition A. This obtained double-sided pressure-sensitive adhesive sheet was taken as a “double-sided pressure-sensitive adhesive sheet C”.

Next, using the double-sided pressure-sensitive adhesive sheet C, a structure having a structure in which the glass plate (a), the double-sided pressure-sensitive adhesive sheet C, and the glass plate (b) were laminated in this order (glass structure) was obtained as in Example 1. This obtained structure was taken as a “glass structure C”.

In addition, using the double-sided pressure-sensitive adhesive sheet C, a structure having a structure in which the module 1, the double-sided pressure-sensitive adhesive sheet C, and a display panel were laminated in this order (LCD structure) was obtained as in Example 1. This obtained structure was taken as an “LCD structure C”.

Next, the glass structure C and the LCD structure C were introduced into an autoclave and autoclave-treated under the conditions of a pressure of 5 atm and a temperature of 50° C. for 15 minutes. After the autoclave treatment, the glass structure C and the LCD structure C were removed from the autoclave and allowed to stand under a temperature atmosphere of −40° C. for 1 hour.

After the standing, the separation method A was carried out under a temperature condition of −40° C. for each of the glass structure C and the LCD structure C. Then, the state after the separation method A was carried out was checked, and evaluation was performed according to the same criteria in Example 1.

In Example 3, the evaluation result of Good was obtained for the application of the separation method A to the glass structure, and the evaluation result of Good was obtained for the application of the separation method A to the LCD structure.

In all of cases where the cutting tools (i) were used and cases where the cutting tools (ii) were used, the evaluation result of Good was obtained.

TABLE 1

| | | | Exam- | | Exam- |
|---|---|---|---|---|---|
| | | | ple 1 | Example 2 | ple 3 |
| Double-sided | | Pressure- | A | B | C |
| pressure-sensitive | | sensitive | | | |
| adhesive sheet | | adhesive | | | |
| | | composition | | | |
| | | Thickness of | 250 | 250 | 150 |
| | | pressure- | | | |
| | | sensitive | | | |
| | | adhesive layer | | | |
| | | (μm) | | | |
| Separation method | | | A | A | A |
| Separation temperature (° C.) | | | −40 | −40 | −40 |
| Evaluation | Glass | Angle of cutting | Good | Good | Good |
| of | structure | edge: 14° | | | |
| separation | | Angle of cutting | Good | Good | Good |
| | | edge: 10° | | | |
| | LCD | Angle of cutting | Good | Good | Good |
| | structure | edge: 14° | | | |
| | | Angle of cutting | Good | Good | Good |
| | | edge: 10° | | | |

### Comparative Example 1

A double-sided pressure-sensitive adhesive sheet composed of only a pressure-sensitive adhesive layer having a thickness of 250 μm was produced as in Example 1 using the pressure-sensitive adhesive composition A. This obtained double-sided pressure-sensitive adhesive sheet was taken as a “double-sided pressure-sensitive adhesive sheet A”.

A structure having a structure in which the glass plate (a), the double-sided pressure-sensitive adhesive sheet A, and the glass plate (b) were laminated in this order (glass structure) was obtained as in Example 1. This obtained structure was taken as a “glass structure A”.

In addition, a structure having a structure in which the module 1, the double-sided pressure-sensitive adhesive sheet A, and a display panel were laminated in this order (LCD structure) was obtained as in Example 1. This obtained structure was taken as an “LCD structure A”.

Next, the glass structure A and the LCD structure A were introduced into an autoclave and autoclave-treated under the conditions of a pressure of 5 atm and a temperature of 50° C. for 15 minutes. After the autoclave treatment, the glass structure A and the LCD structure A were removed from the autoclave and allowed to stand under a temperature atmosphere of −40° C. for 1 hour.

After the standing, the following separation method B was carried out under a temperature condition of −40° C. for each of the glass structure A and the LCD structure A.

Then, the state after the separation method B was carried out was checked, and evaluation was performed according to the following criteria.

### (The Application of the Separation Method B to the Glass Structure)

Good (∘): Cracking or breakage of the glass plate(s) does not occur.

Poor (x): Cracking or breakage of the glass plate(s) occurs.

### (The Application of the Separation Method B to the LCD Structure)

Good (∘): Cracking or breakage does not occur in the LCD panel and the touch sensor.

Poor (x): Cracking or breakage occurs in at least one of the LCD panel and the touch sensor.

In Comparative Example 1, the evaluation result of Good was obtained for the application of the separation method B to the glass structure, but the evaluation result of Poor was obtained for the application of the separation method B to the LCD structure.

### (Separation Method B)

The separation of plates laminated via a double-sided pressure-sensitive adhesive sheet was performed using a chisel (blade shape: flat blade shape, the angle of the cutting edge: 300, the thickness of the cutting tool: 5 mm).

In the separation method B, the chisel was inserted between the glass plate (a) and the double-sided pressure-sensitive adhesive sheet on a side of the glass structure, and force was applied in the normal direction of the glass structure. In addition, the chisel was inserted between the display panel and the double-sided pressure-sensitive adhesive sheet on a side of the LCD structure, and force was applied in the normal direction of the LCD structure.

### Comparative Example 2

A double-sided pressure-sensitive adhesive sheet composed of only a pressure-sensitive adhesive layer having a thickness of 250 μm was produced as in Example 2 using the pressure-sensitive adhesive composition B. This obtained double-sided pressure-sensitive adhesive sheet was taken as a “double-sided pressure-sensitive adhesive sheet B”.

A structure having a structure in which the glass plate (a), the double-sided pressure-sensitive adhesive sheet B, and the glass plate (b) were laminated in this order (glass structure) was obtained as in Example 2. This obtained structure was taken as a “glass structure B”.

In addition, a structure having a structure in which the module 1, the double-sided pressure-sensitive adhesive sheet B, and a display panel were laminated in this order (LCD structure) was obtained as in Example 2. This obtained structure was taken as an “LCD structure B”.

Next, the glass structure B and the LCD structure B were introduced into an autoclave and autoclave-treated under the conditions of a pressure of 5 atm and a temperature of 50° C. for 1.5 minutes. After the autoclave treatment, the glass structure B and the LCD structure B were removed from the autoclave and allowed to stand under a temperature atmosphere of −40° C. for 1 hour.

After the standing, the separation method B was carried out under a temperature condition of −40° C. for each of the glass structure B and the LCD structure B.

Then, the state after the separation method B was carried out was checked, and evaluation was performed according to the same criteria as Comparative Example 1.

In Comparative Example 2, the evaluation result of Good was obtained for the application of the separation method B to the glass structure, but the evaluation result of Poor was obtained for the application of the separation method B to the LCD structure.

### Comparative Example 3

A double-sided pressure-sensitive adhesive sheet composed of only a pressure-sensitive adhesive layer having a thickness of 175 μm was produced as in Example 3 using the pressure-sensitive adhesive composition C. This obtained double-sided pressure-sensitive adhesive sheet was taken as a “double-sided pressure-sensitive adhesive sheet D”.

A structure having a structure in which the glass plate (a), the double-sided pressure-sensitive adhesive sheet D, and the glass plate (b) were laminated in this order (glass structure) was obtained as in Example 3. This obtained structure was taken as a “glass structure D”.

In addition, a structure having a structure in which the module 1, the double-sided pressure-sensitive adhesive sheet D, and a display panel were laminated in this order (LCD structure) was obtained as in Example 3. This obtained structure was taken as an “LCD structure D”.

Next, the glass structure D and the LCD structure D were introduced into an autoclave and autoclave-treated under the conditions of a pressure of 5 atm and a temperature of 50° C. for 15 minutes. After the autoclave treatment, the glass structure D and the LCD structure D were removed from the autoclave and allowed to stand under a temperature atmosphere of −40° C. for 1 hour.

After the standing, the separation method B was carried out under a temperature condition of −40° C. for each of the glass structure D and the LCD structure D.

Then, the state after the separation method B was carried out was checked, and evaluation was performed according to the same criteria as Comparative Example 1.

In Comparative Example 3, the evaluation result of Good was obtained for the application of the separation method B to the glass structure, but the evaluation result of Poor was obtained for the application of the separation method B to the LCD structure.

### Comparative Example 4

A double-sided pressure-sensitive adhesive sheet composed of only a pressure-sensitive adhesive layer having a thickness of 175 μm was produced as in Example 1 using the pressure-sensitive adhesive composition D. This obtained double-sided pressure-sensitive adhesive sheet was taken as a “double-sided pressure-sensitive adhesive sheet E”.

A structure having a structure in which the glass plate (a), the double-sided pressure-sensitive adhesive sheet E, and the glass plate (b) were laminated in this order (glass structure) was obtained as in Example 1. This obtained structure was taken as a “glass structure E”.

In addition, a structure having a structure in which the module 1, the double-sided pressure-sensitive adhesive sheet E, and a display panel were laminated in this order (LCD structure) was obtained as in Example 3. This obtained structure was taken as an “LCD structure E”.

Next, the glass structure E and the LCD structure E were introduced into an autoclave and autoclave-treated under the conditions of a pressure of 5 atm and a temperature of 50° C. for 15 minutes. After the autoclave treatment, the glass structure E and the LCD structure E were removed from the autoclave and allowed to stand under a temperature atmosphere of −80° C. for 1 hour.

After the standing, the separation method B was carried out under a temperature condition of −80° C. for each of the glass structure E and the LCD structure E.

Then, the state after the separation method B was carried out was checked, and evaluation was performed according to the same criteria as Comparative Example 1.

In Comparative Example 4, the evaluation result of Good was obtained for the application of the separation method B to the glass structure, but the evaluation result of Poor was obtained for the application of the separation method B to the LCD structure.

### Comparative Example 5

A double-sided pressure-sensitive adhesive sheet composed of only a pressure-sensitive adhesive layer having a thickness of 150 μm was produced as in Example 1 using the pressure-sensitive adhesive composition A. This obtained double-sided pressure-sensitive adhesive sheet was taken as a “double-sided pressure-sensitive adhesive sheet F”.

A structure having a structure in which the glass plate (a), the double-sided pressure-sensitive adhesive sheet F, and the glass plate (b) were laminated in this order (glass structure) was obtained as in Example 1. This obtained structure was taken as a “glass structure F”.

In addition, a structure having a structure in which the module 1, the double-sided pressure-sensitive adhesive sheet F, and a display panel were laminated in this order (LCD structure) was obtained as in Example 1. This obtained structure was taken as an “LCD structure F”.

Next, the glass structure F and the LCD structure F were introduced into an autoclave and autoclave-treated under the conditions of a pressure of 5 atm and a temperature of 50° C. for 15 minutes. After the autoclave treatment, the glass structure F and the LCD structure F were removed from the autoclave and allowed to stand under a temperature atmosphere of −80° C. for 1 hour.

After the standing, the separation method B was carried out under a temperature condition of −80° C. for each of the glass structure F and the LCD structure F.

Then, the state after the separation method B was carried out was checked, and evaluation was performed according to the same criteria as Comparative Example 1.

In Comparative Example 5, the evaluation result of Good was obtained for the application of the separation method B to the glass structure, but the evaluation result of Poor was obtained for the application of the separation method B to the LCD structure.

### Comparative Example 6

A double-sided pressure-sensitive adhesive sheet composed of only a pressure-sensitive adhesive layer having a thickness of 175 μm was produced as in Example 2 using the pressure-sensitive adhesive composition B. This obtained double-sided pressure-sensitive adhesive sheet was taken as a “double-sided pressure-sensitive adhesive sheet G”.

A structure having a structure in which the glass plate (a), the double-sided pressure-sensitive adhesive sheet G, and the glass plate (b) were laminated in this order (glass structure) was obtained as in Example 2. This obtained structure was taken as a “glass structure G”.

In addition, a structure having a structure in which the module 1, the double-sided pressure-sensitive adhesive sheet G, and a display panel were laminated in this order (LCD structure) was obtained as in Example 2. This obtained structure was taken as an “LCD structure G”.

Next, the glass structure G and the LCD structure G were introduced into an autoclave and autoclave-treated under the conditions of a pressure of 5 atm and a temperature of 50° C. for 15 minutes. After the autoclave treatment, the glass structure G and the LCD structure G were removed from the autoclave and allowed to stand under a temperature atmosphere of −80° C. for 1 hour.

After the standing, the separation method B was carried out under a temperature condition of −80° C. for each of the glass structure G and the LCD structure G.

Then, the state after the separation method B was carried out was checked, and evaluation was performed according to the same criteria as Comparative Example 1.

In Comparative Example 6, the evaluation result of Good was obtained for the application of the separation method B to the glass structure, but the evaluation result of Poor was obtained for the application of the separation method B to the LCD structure.

TABLE 2

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Double-sided | Pressure- | A | B | C | D | A | B |
| pressure-sensitive | sensitive | | | | | | |
| adhesive sheet | adhesive | | | | | | |
| | composition | | | | | | |
| | Thickness | 250 | 250 | 175 | 175 | 150 | 175 |
| | of pressure- | | | | | | |
| | sensitive | | | | | | |
| | adhesive | | | | | | |
| | layer (μm) | | | | | | |
| Separation method | | B | B | B | B | B | B |
| Separation | | −40 | −40 | −40 | −80 | −80 | −80 |
| temperature (° C.) | | | | | | | |
| Evaluation | Glass | Good | Good | Good | Good | Good | Good |
| of | structure | | | | | | |
| separation | LCD | Poor | Poor | Poor | Poor | Poor | Poor |
| | structure | | | | | | |

In Examples 1 to 3, the structures could be separated without the occurrence of cracking or breakage. In addition, the amount of the adhesive residue on the separated glass plate (a) and the separated display panel was also small. Therefore, the separated glass plate (a) and the separated display panel could be preferably reworked.

### REFERENCE SIGNS LIST

1 structure a
11a plate
11b plate
12 double-sided pressure-sensitive adhesive sheet
2 cutting tool a
a normal direction of plate
b horizontal direction
2′ cutting tool a
21 cutting edge of cutting tool a
22 back portion of cutting tool a
X angle of cutting edge
Y thickness of cutting tool a
a′ thickness direction of cutting tool a
2″ cutting tool a
41 blade portion in cutting tool a
p angle of tip of triangular blade
5 display
51 display panel
52 double-sided pressure-sensitive adhesive sheet
53 touch sensor
54 adhesive layer
55 glass plate
61 structure a
62, 62′ mechanism that can place the cutting tool a between the double-sided pressure-sensitive adhesive sheet and the plate on a side of the structure a and apply force in the normal direction of the plate
621 cutting tool a
622 guide rail
623 gear
C direction in which mechanism 62 moves
C′ direction in which mechanism 62′ moves

1. A method of separating two plates laminated via a double-sided pressure-sensitive adhesive sheet, comprising
placing a cutting tool having a cutting edge angle of not more than 25° and a thickness of not more than 20 mm, on a side of a structure composed of a double-sided pressure-sensitive adhesive sheet and two plates, between the double-sided pressure-sensitive adhesive sheet and the plate, and applying force in a normal direction of the plate.

2. The method of separating plates according to claim 1, wherein temperature in separating the plates is a temperature at which a storage modulus of a pressure-sensitive adhesive layer of the double-sided pressure-sensitive adhesive sheet measured by dynamic viscoelasticity measurement is not less than 1.0×10⁷ Pa.

3. The method of separating plates according to claim 1, wherein the double-sided pressure-sensitive adhesive sheet is a double-sided acrylic pressure-sensitive adhesive sheet having an acrylic pressure-sensitive adhesive layer.

4. The method of separating plates according to claim 1, wherein at least one of the two plates is an optical member.

5. An apparatus for separating two plates laminated via a double-sided pressure-sensitive adhesive sheet,
comprising a cutting tool having a cutting edge angle of not more than 25° and a thickness of not more than 20 mm, and
being capable of placing the cutting tool, on a side of a structure composed of a double-sided pressure-sensitive adhesive sheet and two plates, between the double-sided pressure-sensitive adhesive sheet and the plate and applying force in a normal direction of the plate.

6. The method of separating plates according to claim 2, wherein the double-sided pressure-sensitive adhesive sheet is a double-sided acrylic pressure-sensitive adhesive sheet having an acrylic pressure-sensitive adhesive layer.

7. The method of separating plates according to claim 2, wherein at least one of the two plates is an optical member.

8. The method of separating plates according to claim 3, wherein at least one of the two plates is an optical member.

9. The method of separating plates according to claim 6, wherein at least one of the two plates is an optical member.
